(19) United States
(12) Patent Application Publication
(10) Pub. No.: US 2003/0197906 A1
(43) Pub. Date: Oct. 23, 2003

(54) Optical element, metal mold therefor and optical element producing method

(75) Inventors: Kazumi Furuta, Tokyo (JP); Yuichi Akanabe, Tokyo (JP); Masahiro Morikawa, Tokyo (JP); Osamu Masuda, Tokyo (JP)

Correspondence Address: FRISHAUF, HOLTZ, GOODMAN & CHICK, PC, 767 THIRD AVENUE, 25TH FLOOR, NEW YORK, NY, 10017-2023, US

(73) Assignee: Konica Corporation, Tokyo (JP)

(21) Appl. No.: 10/412,996

(22) Filed: Apr. 14, 2003

(30) Foreign Application Priority Data
Apr. 23, 2002 (JP) 2002-121224

(51) Int. Cl. G02B 5/32

(52) U.S. Cl. 359/15

(57) ABSTRACT

An optical element is provided with a first optical surface; a second optical surface opposite to the first optical surface so that a light flux incident onto the first optical surface and is emitted from the second optical surface, wherein at least one of the first and second optical surfaces is a curved optical surface having a refracting power; and a cyclic pattern structure having the characteristic of form birefringence and provided on the curved optical surface, wherein a distance of a pitch of a pattern in the cyclic pattern structure is smaller than the wavelength of the light flux.

### BACKGROUND OF THE INVENTION

The present invention relates to an optical element, a base material, a metal mold therefor, an optical pickup device, an optical element processing method, a base material processed by the aforementioned method, and an electron beam pattern-drawing apparatus, and in particular, to an objective lens that is manufactured through an injection molding method and is of hologram structure and of double refraction phase structure.

Heretofore, CD and DVD, for example, have been used widely as an information recording medium, and many optical elements have been used in a precision device such as a reading device (magneto-optical disk device) that reads the aforementioned recording media.

What is shown in FIG. 36, for example, is given as an example of an optical pickup device such as a reading device employing the optical element stated above exemplified by an optical lens.

In optical pickup device 900 shown in FIG. 36, a laser beam coming from an unillustrated semiconductor laser is converged by objective lens 902 up to the diffraction limit to be irradiated on magneto-optical disk 901 (magneto-optical recording medium) so that it picks up recorded signals and is reflected. The reflected laser beam coming from the magneto-optical disk 901 enters the objective lens 902 to become a collimated light, then, is transmitted through ¼ wavelength plate 903 to be changed in terms of a polarized light direction, and enters hologram plate 904 which transmits an ordinary light as 0-th order diffracted light, and diffracts a polarized light of the incident light as the +first order diffracted light and the −first order diffracted light, thus, the laser beam is split into three light-fluxes, and enters multi-pattern light detector 905.

On a separation light-receiving area (light-receiving element) of the multi-pattern light detector 905, there is formed each spot to form a construction so that focus errors may be detected by the +first order diffracted light and tracking errors may be detected by 0-th order diffracted light and the −first order diffracted light.

Incidentally, in the conventional optical pickup device, there has been a problem that the number of parts to be incorporated such as an objective lens, a hologram plate and a ¼ wavelength plate to be used as an optical element is large, resulting in cost increase.

An objective lens, in particular, is an optical lens that is made of glass in many cases, resulting in primary causes for the cost increase stated above.

In addition, it is necessary to conduct a process for obtaining a prescribed form on the surface of the base material, for manufacturing a hologram plate and a wavelength plate, and it is therefore necessary to conduct the process for each of the hologram plate and the wavelength plate, which is not preferable from the viewpoint of mass production, and a decline of productivity has been caused.

Further, each of the hologram plate, the wavelength plate and the objective lens is constituted separately, and therefore, all of these are required to be moved in the case of alignment, and a mechanism for moving these objects needs to be large, thus, a space occupied by various types of optical members is large, resulting in a problem that it is impossible to contribute to downsizing of the optical pickup device.

In addition, with respect to an optical element, such as an optical lens, for example, used in the devices mentioned above, an optical lens that is made of resin is preferred to that made of glass from the viewpoint of low cost and downsizing, and for manufacturing the optical lens made of resin, it is also necessary to form a molding die for injection molding. In this case, microscopic structures have been formed on an optical functional surface and on a molding die by general cutting processing and by an exposure device employing a method of light exposure, in the past. However, when trying to form microscopic structures on a molding die by the molding technology and a cutting tool in the processing technology used presently, there have been problems that precise processing of submicron order or less cannot be conducted because of poor processing accuracy and of limitation of the strength and life of cutting tools and that it is possible to conduct processing on nothing but a flat material, because it is necessary to form accurately the structure that is shorter than a wavelength of light irradiated on a non-flat surface, for precision processing of the optical element or for generation of photonic crystal, in particular, because a depth of processing on a base material is controlled by an amount of energy for exposure.

### SUMMARY OF THE INVENTION

The invention has been achieved in view of the aforementioned circumstances and its object is to provide an optical element, a base material, a metal mold therefor, an optical pickup device, an optical element processing method, a base material processed by that method and an electron beam pattern-drawing apparatus wherein it is possible to contribute to downsizing and cost reduction of the apparatus by reducing the number of parts while preventing a decline of productivity of optical pickup devices and optical elements, and it is possible to conduct processing of a base material changing in three-dimensional way on the basis of submicron order for the base material for the optical elements used in the aforesaid optical pickup devices and optical elements.

The object mentioned above can be attained by the structure or the method described in each of the following items.

An optical element described in Structure 1 is one that has on its one side a curved surface section, and can make an incident light entering the optical element from the other side (first surface) thereof to emerge through the one side (second surface) as an emerging light, wherein there is provided on at least one side stated above a hologram structure wherein the incident light is split in different directions of different diffraction order numbers to emerge from the one side mentioned above.

An optical element described in Structure 2 is characterized in that the incident light mentioned above is split in three different directions of 0-th order diffraction, +first order diffraction and −first order diffraction by the hologram structure to emerge respectively from the one side mentioned above.

An optical element described in Structure 3 is characterized in that the hologram structure is one which transmits an incident light entering through the aforesaid one side and makes the incident light to emerge from the aforesaid other side.

An optical element described in Structure 4 is characterized in that there is provided, on the aforesaid other side, a double refraction phase structure which causes a phase difference on each of linear polarization on one side and that on the other side among linear polarizations which respectively oscillate in at least directions each being perpendicular to the other in a plane that crosses the advancing direction of light.

An optical element described in Structure 5 is characterized in that a diffraction grating structure is provided on the aforesaid other side.

An optical element described in Structure 6 is characterized in that the aforementioned hologram structure is a diffraction grating structure.

An optical element described in Structure 7 is characterized in that the aforementioned diffraction grating structure is a binary structure composed of a plurality of concavo-convex portions.

An optical element described in Structure 8 is characterized in that the aforementioned diffraction grating structure is a blaze structure including an inclined portion and a side wall portion.

An optical element described in Structure 9 is characterized in that an antireflection structure that prevents reflection on the surface is provided on the aforementioned hologram structure, the double refraction phase structure or on the diffraction grating structure.

An optical element described in Structure 10 is characterized in that the aforementioned other side includes a curved surface portion.

An optical element described in Structure 11 is characterized in that a curved surface portion which can converge an emerging light that emerges from the aforementioned one side is formed on either one of the aforementioned one side and the other side, or on both of them.

An optical element described in Structure 12 is characterized in that a convex portion having the first width and a concave portion having the second width that is shorter than the first width are formed alternatively in the double refraction phase structure.

An optical element described in Structure 13 is characterized in that the first concavo-convex portion wherein the first convex portion having the first width and the first concave portion having the second width that is different from the first width are formed alternatively and the second concave portion that is formed with the third width which is different from the first width and from the second width, are formed alternatively.

An optical element described in Structure 14 is characterized in that a diffraction grating is formed at each pitch to be inclined on a curved surface portion on at least one surface, and at least one pitch of the diffraction grating includes a side wall portion that rises from the curved surface at the position of each end of the pitch, and an inclined portion that is formed between adjacent side wall portions.

A base material described in Structure 15 is characterized in that the optical element is formed by an objective lens.

A base material described in Structure 16 is a base material having on at least one side thereof an pattern-drawn field on which a drawing pattern is formed when beam scanning is conducted, wherein the pattern-drawn field disperses light that emerges from the pattern-drawn field into three different directions of 0-th order, +first order and −first order to emerge respectively, and has a hologram structure for transmitting an incident light that enters from the side of the pattern-drawn field.

A base material described in Structure 17 is characterized in that the pattern-drawn field has a curved surface portion.

A base material described in Structure 18 is a base material provided with a first pattern-drawn field on which a first drawing pattern is drafted and formed on the surface of one side when beam scanning is conducted, and with a second pattern-drawn field on which a second drawing pattern that is different from the first drawing pattern is drafted, wherein the first pattern-drawn field disperses light that emerges from the first pattern-drawn field into three different directions of 0-th order, +first order and −first order to emerge respectively, and has a hologram structure for transmitting an incident light that enters from the side of the pattern-drawn field, and the second pattern-drawn field has a double refraction phase structure which causes a phase difference on each of linear polarization on one side and that on the other side among linear polarizations which respectively oscillate in at least directions each being perpendicular to the other in a plane that crosses the advancing direction of light.

A base material described in Structure 19 is a base material provided with a first pattern-drawn field on which a first drawing pattern is drafted and formed on the surface of one side when electron beam scanning is conducted, and with a second pattern-drawn field on which a second drawing pattern that is different from the first drawing pattern is drafted, wherein the first pattern-drawn field disperses light that emerges from the first pattern-drawn field into three different directions of 0-th order, +first order and −first order to emerge respectively, and has a hologram structure for transmitting an incident light that enters from the side of the pattern-drawn field, and the second pattern-drawn field has a diffraction grating structure which diffracts light that enters the first pattern-drawn field and emerges from the second pattern-drawn field.

In Structure 20, there is defined a metal mold for forming either one of the aforementioned base materials.

An optical pickup device described in Structure 21 is one having therein a magneto-optical recording medium, an optical element that converges a laser beam emitted from a laser supply source, then, leads the converged laser beam to the magneto-optical recording medium and disperses light reflected on the magneto-optical recording medium, and each detecting section that detects errors such as tracking errors and focus errors based on each split light, wherein the optical element has, on its one side, a hologram structure which can disperse the reflected light into each diffracted light in three different directions of 0-th order, +first order and −first order so that they may emerge respectively from the aforesaid one side and can transmit an incident light that enters from the aforesaid one side to make the incident light to emerge from the other side, and has, on the aforesaid other side, a double refraction phase structure which causes a phase difference on each of linear polarization on one side and that on the other side among linear polarizations which respectively oscillate in at least directions each being perpendicular to the other in a plane that crosses the advancing direction of light.

An optical pickup device described in Structure 22 is one having therein a magneto-optical recording medium, a first optical element that makes a laser beam emitted from a laser supply source to be a collimated light, a second optical element that converges the collimated light so that the magneto-optical recording medium may be irradiated, and a photo-detector that receives the laser beam reflected on the magneto-optical recording medium through the second optical element, wherein recorded information on the magneto-optical recording medium is read based on output of the photo-detector, and the first optical element has, on its one side, a hologram structure which can disperse the laser beam into each diffracted light in each of three different directions of 0-th order, +first order and −first order so that it may emerge from the aforesaid one side.

An optical element processing method described in Structure 23 is one for forming a microscopic structure for the first base material including a curved surface portion, wherein the microscopic structure is drafted on the curved surface portion by an electron beam, and there is included a drawing step in which the drawing is conducted while the drawing line that is for the hologram structure and is roughly in a concavo-convex form in a section and is roughly in a circular form on a plane is adjusted for the curved surface portion in terms of height by relative movement of a focus position of the electron beam for the first base material, a position adjustment in the direction of the surface is conducted.

An optical element processing method described in Structure 24 develops the first base material irradiated by the electron beam, then, conducts electroforming on the surface of the developed first base material, and has a step to form a first metal mold for molding.

An optical element processing method described in Structure 25 develops the first base material irradiated by the electron beam, then, conducts electroforming on the first base material which has been subjected to etching, and has a step to form a first metal mold for molding.

An optical element processing method described in Structure 26 further has the second drawing step for drawing a double refraction phase structure on the pattern-drawn field of the second base material for the second base material including an pattern-drawn field by an electron beam, the step for developing the second base material irradiated by the electron beam, and for conducting electroforming on the surface of the developed second base material to form the second metal mold for molding, and the step to arrange the first and second metal molds so that they may face each other and thereby to form, through injection molding, an optical element having on its surface on one side a hologram structure and having on its surface on the other side a double refraction phase structure.

An optical element processing method described in Structure 27 further has the second drawing step for drawing a diffraction grating on the pattern-drawn field of the second base material for the second base material including an pattern-drawn field by an electron beam, the step for developing the second base material irradiated by the electron beam, and for conducting electroforming on the surface of the developed second base material to form the second metal mold for molding, and the step to arrange the first and second metal molds so that they may face each other and thereby to form, through injection molding, an optical element having on its surface on one side a hologram structure and having on its surface on the other side a diffraction grating structure.

An optical element processing method described in Structure 28 further has the second drawing step for drawing a diffraction grating on the curved surface portion of the second base material for the second base material including a curved surface portion drafted by an electron beam, the step for developing the second base material irradiated by the electron beam, and for conducting electroforming on the surface of the developed second base material to form the second metal mold for molding, and the step to arrange the first and second metal molds so that they may face each other and thereby to form, through injection molding, a base material having on its curved surface portion on one side a hologram structure and having on its curved surface on the other side a diffraction grating structure inclined for each pitch.

An optical element processing method described in Structure 29 is characterized in that the second drawing step extracts dose distribution characteristics for which the distribution of dose amount for the scanning position is defined in advance, when forming by inclining for each pitch, in accordance with an inclination angle on the curved surface portion, and conducts drawing of the curved surface portion of the base material while calculating the amount of dose, based on the extracted dose distribution characteristics.

An optical element processing method described in Structure 30 is characterized in that injection molding is conducted for the first metal mold for molding, and a step to form the base material is included.

An optical element processing method described in Structure 31 is characterized in that a first metal mold for molding is used for the base material, and a step for conducting drawing on the first metal mold is provided.

An optical element processing method described in Structure 32 is characterized in that a second metal mold for molding is used for the base material, and a step for conducting drawing on the second metal mold is provided.

In the Structure 33, the base material processed by either one of the aforementioned optical element processing methods is defined, and in addition, the base material is formed by an optical element in the invention described in the Structure 34.

An electron beam pattern-drawing apparatus described in Structure 35 is characterized to include an electron beam radiating means that radiates an electron beam, an electron lens that makes a position of focus of the electron beam radiated by the electron beam radiating means to be variable, a mounting stand on which a base material having a curved surface portion on an pattern-drawn field when irradiated by the electron beam is mounted, a measuring means for measuring the position of drawing drafted on the base material when forming a hologram structure on the curved surface portion of the base material, and a control means that adjusts a current value of the electron lens based on the drawing position measured by the measuring means, and controls a focus position of the electron beam variably in accordance with the drawing position to control so that drawing on the curved surface portion and on the hologram structure portion of the base material may be conducted.

An electron beam pattern-drawing apparatus described in Structure 36 is characterized to include an electron beam radiating means that radiates an electron beam,

a mounting stand on which a base material having a curved surface portion on an pattern-drawn field when irradiated by the electron beam is mounted,

a drive means that drives the mounting stand,

a measuring means for measuring the position of drawing drafted on the base material when forming a hologram structure on the curved surface portion of the base material, and a control means that makes the drive means to lift and lower the mounting stand based on the drawing position measured by the measuring means, then, controls variably the focus position of the electron beam radiated by the electron beam radiating means in accordance with the drawing position, and controls so that drawing on the curved surface portion of the base material and on the hologram structure portion may be conducted.

An electron beam pattern-drawing apparatus described in Structure 37 is characterized to include an electron beam radiating means that radiates an electron beam, an electron lens that makes a focus position of the electron beam radiated by the electron beam radiating means to be variable, a mounting stand on which a base material having a curved surface portion on an pattern-drawn field when irradiated by the electron beam is mounted, a measuring means for measuring the position of drawing drafted on the base material when forming a double refraction phase structure on the curved surface portion of the base material, and a control means that adjusts an electric current value of the electron lens based on the drawing position measured by the measuring means, then, controls variably a focus position of the electron beam in accordance with the drawing position, and controls so that drawing on the curved surface portion of the base material and on the double refraction phase structure portion may be conducted.

An electron beam pattern-drawing apparatus described in Structure 38 is characterized to include an electron beam radiating means that radiates an electron beam, a mounting stand on which a base material having a curved surface portion on an pattern-drawn field when irradiated by the electron beam is mounted, a drive means that drives the mounting stand, a measuring means for measuring the position of drawing drafted on the base material when forming a double refraction phase structure on the curved surface portion of the base material, a control means that makes the drive means to lift and lower the mounting stand based on the drawing position measured by the measuring means, then, controls variably the focus position of the electron beam radiated by the electron beam radiating means in accordance with the drawing position, and controls so that drawing on the curved surface portion of the base material and on the hologram structure portion may be conducted.

An electron beam pattern-drawing apparatus described in Structure 39 is characterized to include an electron beam radiating means that radiates an electron beam, an electron lens that makes a focus position of the electron beam radiated by the electron beam radiating means to be variable, a mounting stand on which each of the first and second base materials having a curved surface portion on an pattern-drawn field when irradiated by the electron beam is mounted at need, a measuring means that measures the position of drawing on the first base material when forming a hologram structure on the first base material and measures the position of drawing on the second base material when forming a double refraction phase structure on the second base material, a storing means that stores dose distribution characteristics wherein there is defined beforehand the dose amount distribution for the scanning position that reflects a dose amount at each pitch portion of diffraction grating that is inclined in accordance with inclination position on the curved surface portion when forming a double refraction phase structure on the curved surface portion of the second base material, and a control means that controls variably a focus position of the electron beam in accordance with the drawing position by adjusting an electric current value of the electron lens, based on the drawing position measured by the measuring means, when drawing the curved surface portion and a hologram structure on the first base material, or controls variably a focus position of the electron beam in accordance with the drawing position by adjusting an electric current value of the electron lens, based on the drawing position measured by the measuring means, when drawing the curved surface portion and a double refraction phase structure on the second base material, and conducts drawing on the curved surface portion and of a double refraction phase structure portion on the base material, while calculating the dose amount, based on the dose distribution characteristics in the storing means, within a focal depth at the focus position, and to conduct drawing for each of the first and second base materials independently to generate the first and second base materials as one base material in the process after the drawing.

An electron beam pattern-drawing apparatus described in Structure 40 is characterized to include an electron beam radiating means that radiates an electron beam, an electron lens that makes a focus position of the electron beam radiated by the electron beam radiating means to be variable, a mounting stand on which each of the first and second base materials having a curved surface portion on an pattern-drawn field when irradiated by the electron beam is mounted at need, a measuring means that measures the position of drawing on the first base material when forming a hologram structure on the first base material and measures the position of drawing on the second base material when forming a diffraction grating structure on the second base material, a storing means that stores dose distribution characteristics wherein there is defined beforehand the dose amount distribution for the scanning position that reflects a dose amount at each pitch portion of diffraction grating that is inclined in accordance with inclination position on the curved surface portion when forming a diffraction grating structure on the curved surface portion of the second base material, and a control means that controls variably a focus position of the electron beam in accordance with the drawing position by adjusting an electric current value of the electron lens, based on the drawing position measured by the measuring means, when drawing the curved surface portion and a hologram structure on the first base material, or controls variably a focus position of the electron beam in accordance with the drawing position by adjusting an electric current value of the electron lens, based on the drawing position measured by the measuring means, when drawing the curved surface portion and a diffraction grating structure on the second base material, and conducts drawing on the curved surface portion and on a diffraction grating structure portion on the base material, while calculating the dose amount, based on the dose distribution characteristics in the storing means, within a focal depth at the focus position, and to conduct drawing for each of the first and second base materials independently to generate the first and second base materials as one base material in the process after the drawing.

### BRIEF DESCRIPTION OF THE DRAWINGS

FIG. 1 is an illustration showing an example of a schematic structure of a base material (optical element) relating to an embodiment of the invention.

FIG. 2 is an illustration showing an example of a schematic structure of a hologram structure of a base material (optical element) relating to an embodiment of the invention.

FIG. 3 is an illustration showing an example of a schematic structure of a double refraction phase structure (wavelength plate structure) of a base material (optical element) relating to an embodiment of the invention.

FIG. 4(A) is an illustration showing characteristics of TM wave that is generated by a structure of a wavelength plate and has an incident angle of 0° and FIG. 4(B) is an illustration showing characteristics of TE wave that is generated by a structure of a wavelength plate and has an incident angle of 0°.

FIG. 5(A) is an illustration showing characteristics of TM wave that is generated by a structure of a wavelength plate and has an incident angle of 24° and FIG. 5(B) is an illustration showing characteristics of TE wave that is generated by a structure of a wavelength plate and has an incident angle of 24°.

FIG. 6(A) is an illustration showing characteristics of TM wave that is generated by a structure of a wavelength plate and has an incident angle of 46° and FIG. 6(B) is an illustration showing characteristics of TE wave that is generated by a structure of a wavelength plate and has an incident angle of 46°.

Each of FIG. 7(A) and FIG. 7(B) is an illustration for illustrating another embodiment of the hologram structure, and FIG. 7(A) is an illustration of a principle for illustrating the diffraction order of an optical system, and FIG. 7(B) is a sectional view of the structure.

FIG. 8 is an illustration showing characteristics of TE wave generated by a hologram structure in FIG. 7.

FIG. 9 is an illustration showing characteristics of TE wave generated by a hologram structure in FIG. 7.

FIG. 10 is an illustration for illustrating another embodiment of the hologram structure.

FIG. 11 is a functional block diagram showing a schematic structure of the total electron beam pattern-drawing apparatus of the invention.

Each of FIGS. 12(A) and 12(B) is an illustration showing a base material to be subjected to drawing by an electron beam pattern-drawing apparatus shown in FIG. 11, and FIG. 12(C) is an illustration for illustrating a principle of drawing.

FIG. 13 is an illustration for illustrating a principle of a measuring apparatus.

Each of FIGS. 14(A)-14(C) is an illustration for illustrating a method of measuring a face height of a base material.

FIG. 15 is a functional block diagram showing an example of the structure of a more detailed control system of an electron beam pattern-drawing apparatus.

FIG. 16 is a flow chart showing processing procedures in the case of drawing the base material with an electron beam pattern-drawing apparatus of the invention.

FIG. 17 is a flow chart showing processing procedures in the case of drawing the base material with an electron beam pattern-drawing apparatus of the invention.

FIG. 18 is a flow chart showing processing procedures in the case of drawing the base material with an electron beam pattern-drawing apparatus of the invention.

Each of FIGS. 19(A)-19(D) is an illustration for illustrating total processing procedures in the case of forming a metal mold for molding by using a base material and manufacturing a base material.

Each of FIGS. 20(A) and 20(B) is an illustration for illustrating total processing procedures in the case of forming a metal mold for molding by using a base material and manufacturing a base material.

FIG. 21 is an illustration for illustrating total processing procedures in the case of forming a metal mold for molding by using a base material and manufacturing a base material.

FIG. 22 is an illustration showing an example of a schematic structure of a base material relating to an embodiment of the invention.

Each of FIGS. 23(A)-23(D) is an illustration for illustrating total processing procedures in the case of forming a metal mold for molding by using a base material and manufacturing a base material.

Each of FIGS. 24(A)-24(C) is an illustration for illustrating total processing procedures in the case of forming a metal mold for molding by using a base material and manufacturing a base material.

FIG. 25 is an illustration for illustrating total processing procedures in the case of forming a metal mold for molding by using a base material and manufacturing a base material.

FIG. 26 is an illustration showing an example of a schematic structure of a base material relating to an embodiment of the invention.

FIG. 27 is an illustration showing details of the base material shown in FIG. 26.

FIG. 28 is a flow chart showing processing procedures in the case of drawing the base material with an electron beam pattern-drawing apparatus of the invention.

FIG. 29(A) shows a drawing pattern and FIG. 29(B) is an illustration showing dose distribution.

Each of FIGS. 30(A)-30(D) is an illustration for illustrating total processing procedures in the case of forming a metal mold for molding by using a base material and manufacturing a base material.

Each of FIGS. 31(A)-31(C) is an illustration for illustrating total processing procedures in the case of forming a metal mold for molding by using a base material and manufacturing a base material.

FIG. 32 is an illustration showing an example of a schematic structure of a base material relating to an embodiment of the invention.

FIG. 33 is an illustration showing an example of a schematic structure of an optical pickup device employing a base material (optical element) of the invention.

FIG. 34 is an illustration showing an example of a schematic structure of an optical pickup device employing a base material (optical element) of the invention.

FIG. 35 is an illustration showing positional relationship between a magneto-optical disk in the optical pickup device shown in FIG. 34 and a laser beam to be radiated.

FIG. 36 is an illustration showing-conceptually a schematic structure of the conventional optical pickup device.

### DETAILED DESCRIPTION OF THE PREFERRED EMBODIMENT

(Embodiment of the Invention)

An example of the preferable embodiment of the invention will be explained concretely as follows, referring to the drawings.

### First Embodiment

(Explanation of Structure of Optical Element)

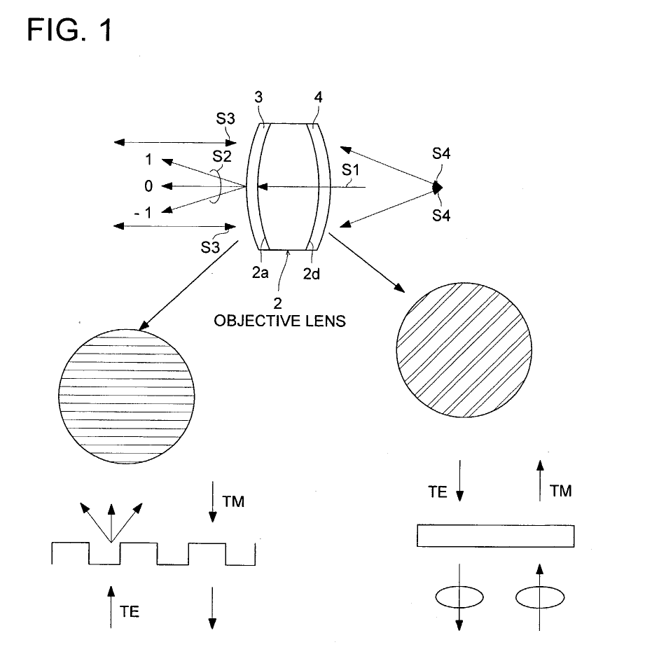

First, a schematic structure of an optical element used in an optical pickup device of the invention will be explained as follows, referring to FIG. 1. FIG. 1 is an illustration for illustrating the structure of an optical element in the present embodiment.

In the optical element in the present embodiment, a hologram structure is formed on the surface on one side of the optical lens and a double refraction phase structure is formed on the surface on the other side of the optical lens, which is a characteristic point.

To be concrete, as shown in FIG. 1, objective lens 2 representing an example of an optical element is a member made of resin capable of making incident light S1 entering the objective lens 2 through surface 2d on the other side to emerge through surface 2a on one side as emergent light S2, and on the surface 2d on the aforesaid one side, there is formed hologram structure 3 that can disperse the incident light S1 into diffracted light in different three directions of 0-th order, +first order and −first order to make them to emerge through the surface 2a on the aforesaid one side, and can transmit an incident light entering through the surface 2a on the aforesaid one side to make the incident light to emerge through the surface 2d on the aforesaid other side.

On the surface 2d on the aforesaid other side of objective lens 2, there is formed wavelength plate structure 4 (to deflect the polarization direction of light by a prescribed angle) representing an example of a double refraction phase structure which causes a phase difference for linear polarization TE wave on one side and linear polarization TM wave on the other side, among linear polarizations TE wave and TM wave which respectively oscillate in at least directions each being perpendicular each other in a plane that crosses the advancing direction of light.

In the hologram structure 3, TM wave (a wave having no electric field component and having magnetic field component only on a plane perpendicular to the advancing direction) among incident light entering through the surface 2a on one side is transmitted and is converged, while, TE wave (a wave having no magnetic field component and having electric field component only on a plane perpendicular to the advancing direction) among incident light entering through the surface 2d on the other side is collimated and then is polarized to 0-th order, +first order and −first order.

In the wave plate structure 4, TM wave, for example, among incident light entering through surface 2a on one side is polarized in a way that the oscillation direction is swung by a prescribed angle, and when the polarized light reflected on the specific location enters through the surface 2d on the other side, polarization is conducted in a way that the oscillation direction is swung, and the polarized light emerges as TM wave.

Incidentally, as a wavelength plate structure, it is preferable to form a function such as, for example, a ¼ wavelength plate. Namely, double refraction is performed before reaching the wavelength plate, then, ¼ rotation is made after entering the wavelength plate and ¼ rotation is made again after returning.

In the case of objective lens 2 made of resin of this kind, hologram structure 3 and wavelength plate structure 4 are formed solidly. Therefore, when the objective lens is used in an optical system such as an optical pickup device, for example, one member can possess three functions of an objective lens, a wavelength plate and a hologram plate. Thus, it is possible to contribute to downsizing of the device by reducing the number of members to miniaturize an area occupied by an optical member.

Further, both of the wavelength plate structure and the hologram structure can be formed collectively on the objective lens by forming a microscopic structure. Since they are formed solidly with resins, it is possible to attain cost reduction and to contribute to mass production of the device by using a molding die.

Further, in the optical pickup device, functions of tracking and focusing can be included in the objective lens, and when conducting tracking, it is not necessary to operate all of the objective lens and the hologram plate as in the past, and the objective lens has only to be operated, which makes an alignment operation for the optical pickup device easy, because the number of members to be operated is only one.

Incidentally, in a concrete form, it is preferable that a detection signal is assigned to 0-th order light, and a signal for focusing and a signal for tracking are assigned respectively to +1 and −1.

Now, the hologram structure 3 of the present embodiment makes three types of light to emerge and generates a spherical wave, which is different from an ordinary polarizing plate that makes only 0-th order light to emerge.

Incidentally, it is acceptable that a hologram structure only is provided on the surface on one side of the objective lens and a wavelength plate is not provided. However, it is preferable, from the viewpoint of efficiency, that the wavelength plate is provided.

In addition, although a function such as a ¼ wavelength plate is formed as a wavelength plate structure in the example stated above, it is also possible to form a ½ wavelength plate and other various wavelength plates as occasion demands, without being limited to the foregoing.

(Base Material)

A base material of the invention is characterized in that a hologram structure is formed on one side of an optical lens. Another embodiment of the invention is characterized in that a function of a wavelength plate (double refraction phase structure) is formed on the other side of the optical lens.

(Hologram Structure)

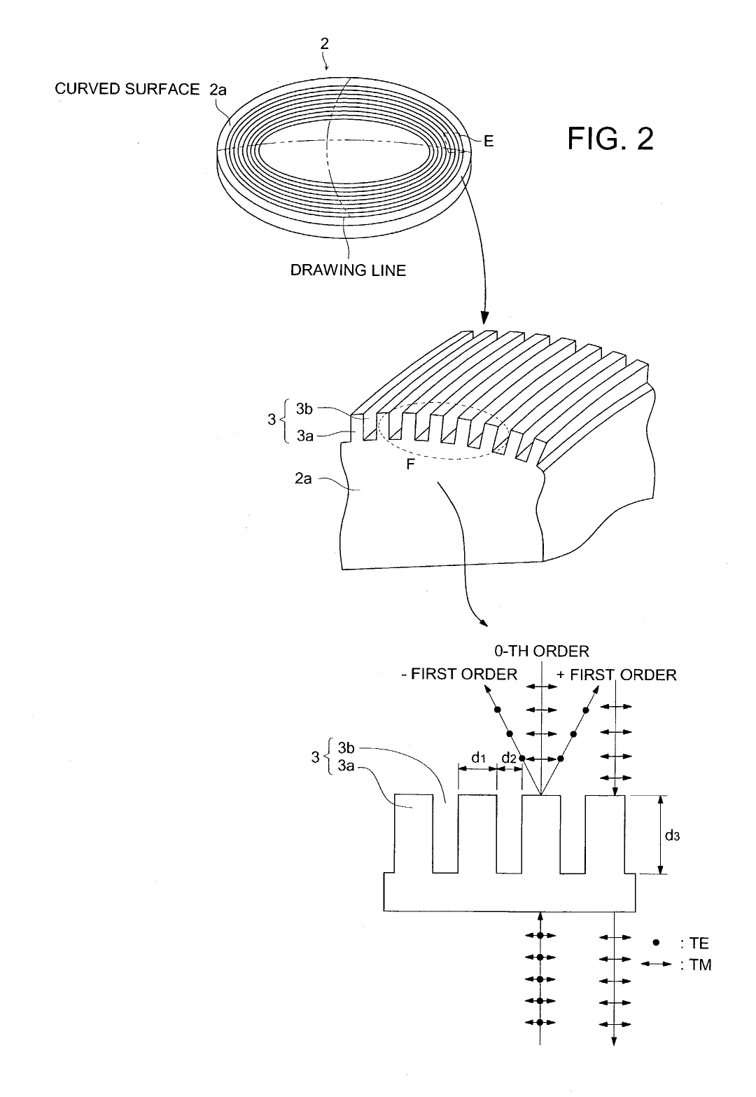

First, the base material to be drawn by an electron beam having the aforementioned characteristic will be explained as follows, referring to FIG. 2-FIG. 10. In FIG. 2, there are disclosed a drawing pattern to be drawn on the base material and a drawing form in its detailed portion.

As shown in the drawing, there is disclosed a circular drawing as an example of a drawing pattern to be drawn on objective lens 2 representing an example of the base material of the present embodiment. In enlarged E portion representing a part of a drawing portion of objective lens 2 that is an example of the base material having curved surface portion 2a on an pattern-drawn field, the objective lens 2 of the base material is formed by hologram structure 3 that is composed of a plurality of concavo-convex portions. Incidentally, it is preferable that the objective lens 2 of the base material is constituted of an optical element such as, for example, a pickup lens.

The hologram structure 3 polarizes and separates light entering or emerging from the curved surface portion 2a into two polarization components of TE wave and TM wave oscillating in at least two directions each being perpendicular to the other in a plane crossing the advancing direction of the aforementioned light. In particular, the TM wave is polarized into the +first order diffracted light and −first order diffracted light, while, TM wave has a function to advance straight as 0-th order diffracted light, and a concavo-convex portion (diffraction grating structure of a binary pattern) composed of convex portion 3a and concave portion 3b is formed on the hologram structure.

In a more detailed way, the hologram structure 3 is formed by a plurality of convex portions 3a each having a height of d3 and a first width of d1 and of concave portions 3b each having a height of d3 and a second width of d2 that is different from the first width of d1, as shown in the enlarged drawing of F portion in FIG. 1.

Incidentally, it is possible to conduct polarization and separation also for light entering vertically, by making the structure in a cycle to be asymmetric.

By constituting the cyclic structure of this kind on the curved surface portion 2a, it is possible to separate light transmitted through the aforementioned structure into the +first order diffracted light and the −first order diffracted light of TE wave (wave having only electric field component and having no magnetic field component in a plane perpendicular to the advancing direction) and the 0-th order diffracted light of TM wave (wave having only magnetic field component and having no electric field component in a plane perpendicular to the advancing direction), in the base material in the present embodiment.

As a practical numerical value of d1, d2 and d3 in FIG. 2, d1=200−0.36×200 nm, d2=0.36×200 nm and d3=2320 nm are preferable under the assumption, for example, that refractive indexₙ of base material (objective lens) is 1.475 and a wavelength is 400 nm.

Incidentally, the establishment of dimensions of d1-d3 and the concavo-convex structure in the hologram structure are not naturally limited the example described above, provided that a function of the hologram structure (polarizing beam splitter) “to separate a progressive wave into 0-th order diffracted light, −first order diffracted light and +first order diffracted light” can be attained.

By providing, on the curved surface portion 2a, the hologram structure 3 having the concavo-convex portion in the form shown in FIG. 2, as stated above, it is possible to polarize and separate light into 0-th order diffracted light, +first order diffracted light and −first order diffracted light.

(Double Refraction Phase Structure)

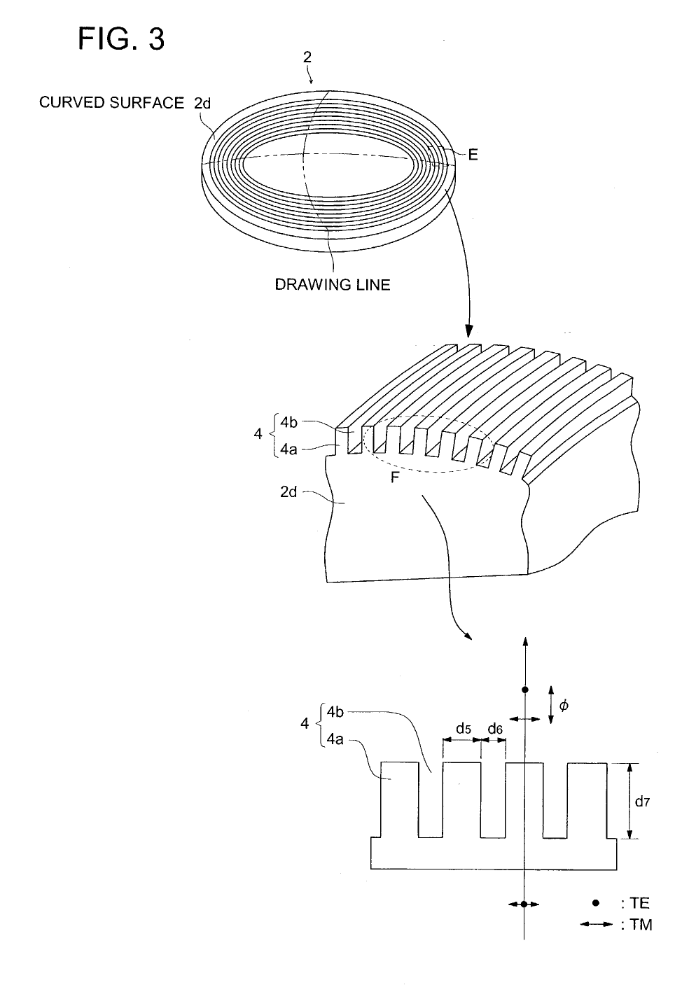

Next, a base material equipped with a double refraction phase structure will be explained by referring to FIG. 3. In FIG. 3, there are disclosed a drawing pattern to be drawn on the base material and a drawing form in its detailed portion.

As shown in the drawing, there is disclosed a circular drawing as an example of a drawing pattern to be drawn on objective lens 2 representing an example of the base material. In enlarged E portion representing a part of a drawing portion of objective lens 2 that is an example of the base material having curved surface portion 2d on an pattern-drawn field, double refraction phase structure 4 composed of a plurality of concavo-convex portions (diffraction grating structure of a binary pattern) is formed on base material (objective lens) 2. Incidentally, it is preferable that the base material (objective lens) 2 is constituted of an optical element such as, for example, a pickup lens.

The double refraction phase structure 4 has convex portion 4a and concave portion 4b and has a function to generate phase difference φ between TE wave representing polarized light on one side and TM wave representing polarized light on the other side among two polarization components TE wave and TM wave oscillating respectively in at least two directions perpendicular to each other in a plane crossing the advancing direction of the light entering the curved surface portion 2d or emerging therefrom.

In a more detailed way, the double refraction phase structure 4 has a cyclic structure that is formed when convex portion 4a having the first width d5 and concave portion 5b having the second width d6 that is shorter than the first width d5 are positioned alternatively, as shown in the enlarged drawing of F portion shown in FIG. 3. Incidentally, the convex portion 4a is formed to be of a height of d7.

In the case of base material (objective lens) 2 of the present embodiment, it is possible to generate phase difference φ between TE wave and TM wave among light transmitted through the aforesaid structure, by providing the cyclic structure mentioned above on the curved surface portion 2d.

As concrete numerical values for d5, d6 and d7 in FIG. 3, it is preferable that d5:d6 is 7:3 and d7 is 1λ, under the condition, for example, that the refractive indexₙ of base material (objective lens) 4 is 2 and a wavelength is λ. Incidentally, in this case, an occasion to have a function equal to a ¼ wavelength plate is supposed, to which, however, the invention is not limited, and it is also possible to arrange to have a function equal to a ½ wavelength plate or to a 1 wavelength plate.

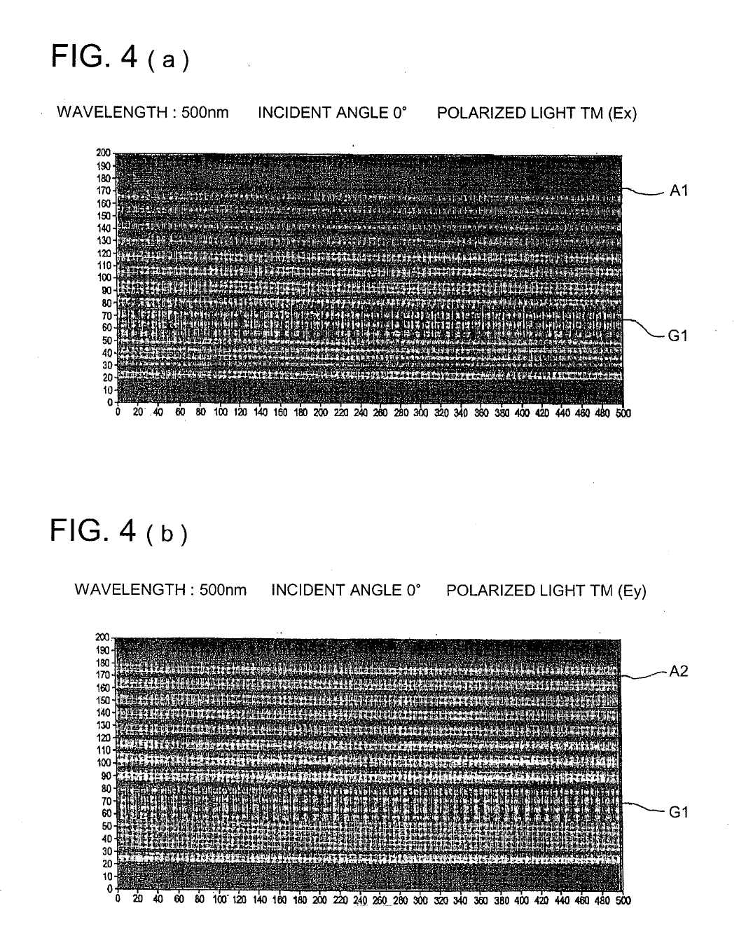

States of waves of TM wave and TE wave wherein phase differences can be generated in the double refraction phase structure 4 under the aforementioned conditions, were analyzed by FDTD method by changing incident angles, and results of the analyses are shown in each of FIGS. 4(A) and 4(B), FIGS. 5(A) and 5(B) and FIGS. 6(A) and 6(B). In FIG. 4(A), there is disclosed the state of TM wave generated by the double refraction phase structure 4 at an incident angle of 0°, and in FIG. 4(B), there is disclosed the state of TE wave generated by the double refraction phase structure 4 at an incident angle of 0°.

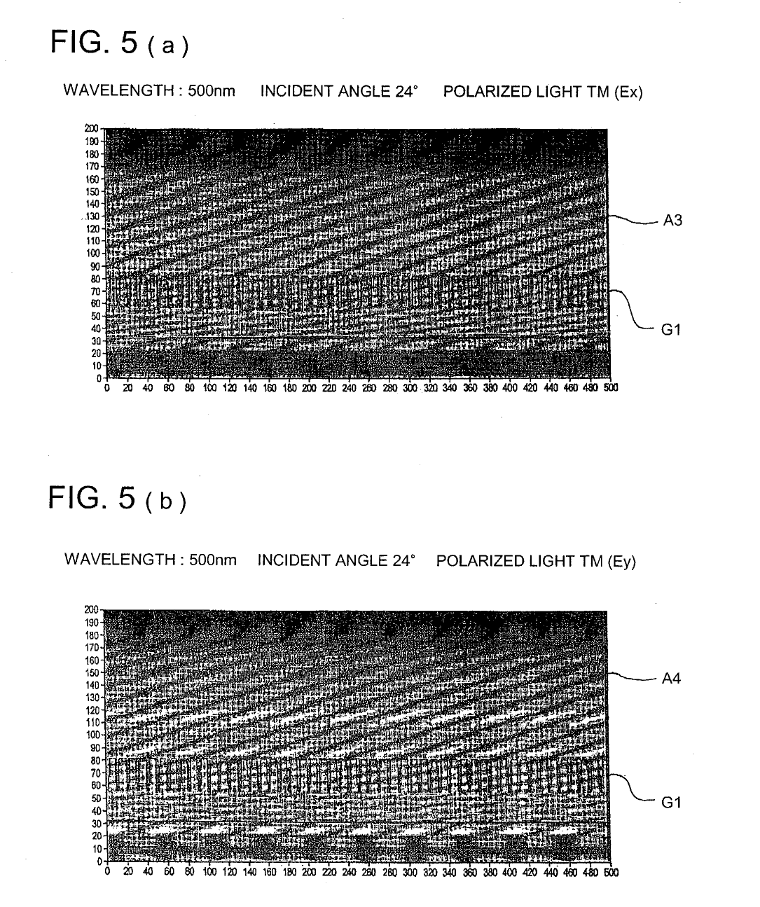

In FIG. 5(A), there is disclosed the state of TE wave generated by the double refraction phase structure 4 at an incident angle of 24°, and in FIG. 4(B), there is disclosed the state of TM wave generated by the double refraction phase structure 4 at an incident angle of 24°.

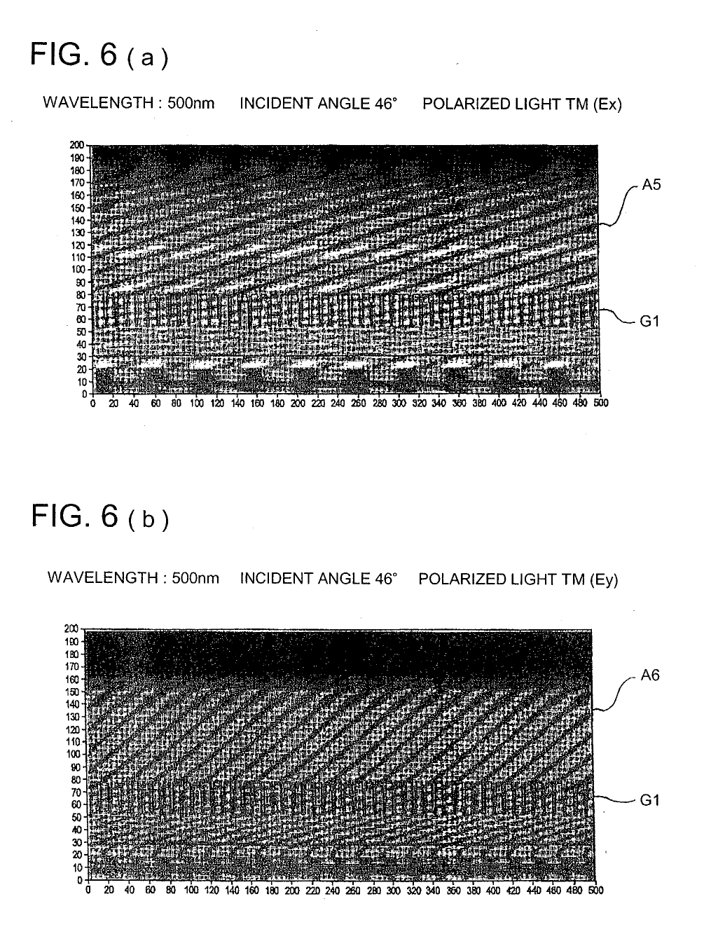

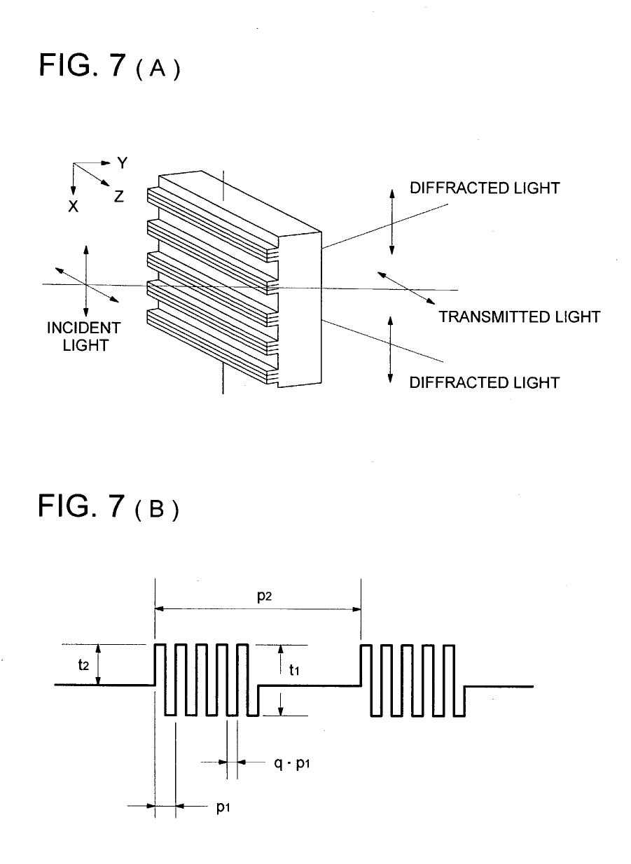

Further, in FIG. 6(A), there is disclosed the state of TM wave generated by the double refraction phase structure 4 at an incident angle of 46°, and in FIG. 6(B), there is disclosed the state of TE wave generated by the double refraction phase structure 4 at an incident angle of 46°.

In the aforementioned drawings, however, it is assumed that light enters in the direction from the lower part toward the upper part in all cases (when a phase difference is generated between TE wave and TM wave of light emerging from the curved surface portion of the base material in the case of estimation of a base material), and a plane wave expanding upward infinitely is supposed. Incidentally, the horizontal axis shows a position of double refraction phase structure G1 along the lateral direction (unit×20 nm), and the vertical axis shows a position along the upward direction perpendicular to double refraction phase structure G1. Further, in this drawing, an occasion where wavelength λ is 500 nm is supposed.

As shown in these drawings, when double refraction phase structure 4 (double refraction phase structure G1 in FIGS. 4(A) and 4(B)) by irregularity in a form shown in FIG. 3 is formed, TM wave A1 and TE wave A2 can be generated properly under the prescribed phase difference, as shown in FIGS. 4(A) and 4(B). Therefore, it is preferable, from the viewpoint of generating properly the phase difference for TE wave and TM wave, that d5-d7 stated above are set to the numerical values shown above.

As stated above, in the results of the simulation wherein a beam advancing perpendicularly and a beam advancing obliquely both to a wavelength plate are made to enter and an effect of the wavelength plate is studied, it was found that the phase is shifted even when the beam enters obliquely. Therefore, the same structure gives a function of a wavelength plate. Incidentally, a critical value of an acceptable incident angle is up to, for example, about 50° or 60°.

However, after all, the establishment of dimensions of d5-d7 and the concavo-convex structure are not naturally limited to the example described above, provided that a function as a double refraction phase structure “to make TE wave and TM wave to generate a phase difference” can be attained.

When forming on a curved surface like an objective lens, an incident angle is also inclined, and even in this case, when an incident angle shown in FIG. 5 is 24°, for example, TM wave A3 and TE wave A4 can respectively be generated properly with a prescribed phase difference, and even in the case where an incident angle shown in FIG. 6 is 46°, TM wave A5 and TE wave A6 can respectively be generated properly with a prescribed phase difference. Therefore, even in the case of forming on an objective lens, the establishment stated above does not cause problems.

By constructing the double refraction phase structure 4 by irregularity having a form shown in FIG. 2, on curved surface portion 2d as stated above, TE wave and TM wave can be made to generate a phase difference.

(Another Embodiment I of a Hologram Structure)

Incidentally, as an embodiment of the hologram structure 3, it is also possible to form with an embodiment of concavo-convex structure as shown in FIG. 7, without being limited to the one having the concavo-convex structure shown in FIG. 2.

To be concrete, as shown in FIG. 7(B), the hologram structure 3 forms a cyclic structure by a concave-convex portion composed of a convex portion having a first width p1-qp1 and a concave portion having a second width qp1 and by plane surface portion.

In this case, one cycle composed of one concavo-convex portion and one plane surface portion is made to be with width p2, a height of one convex portion is made to be t1, and a height from the plane surface portion to a vertex of the convex portion is made to be t2.

In this case, in the case of refractive indexₙ of the lens=1.475 and wavelength λ of incident light=400 nm, it is preferable that concrete numerical values of the structure in FIG. 7(B) represent, for example, t1=2320 nm, t2=1160 nm, q=0.36, p1=200 nm and p2=2000 nm.

Even in the case of this structure, when light enters, it is polarized respectively into 0-th order transmitted light (incident light), +first order diffracted light (for example, for tracking) and −first order diffracted light (for focusing) as shown in FIG. 7(A).

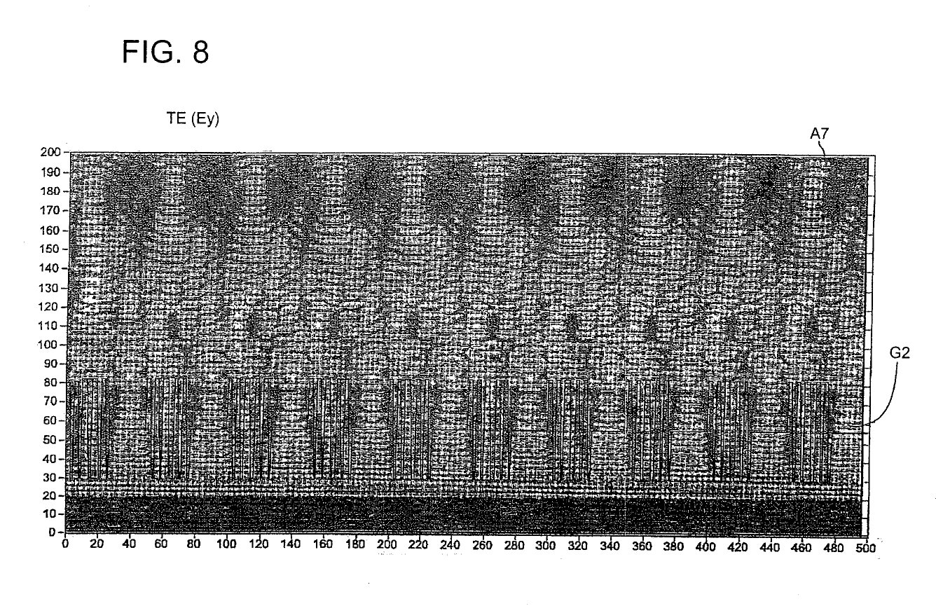

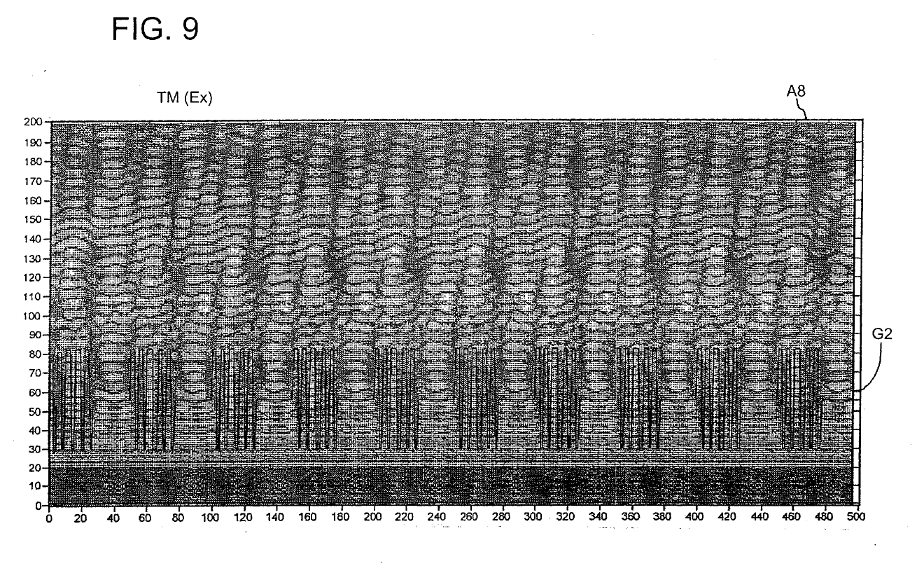

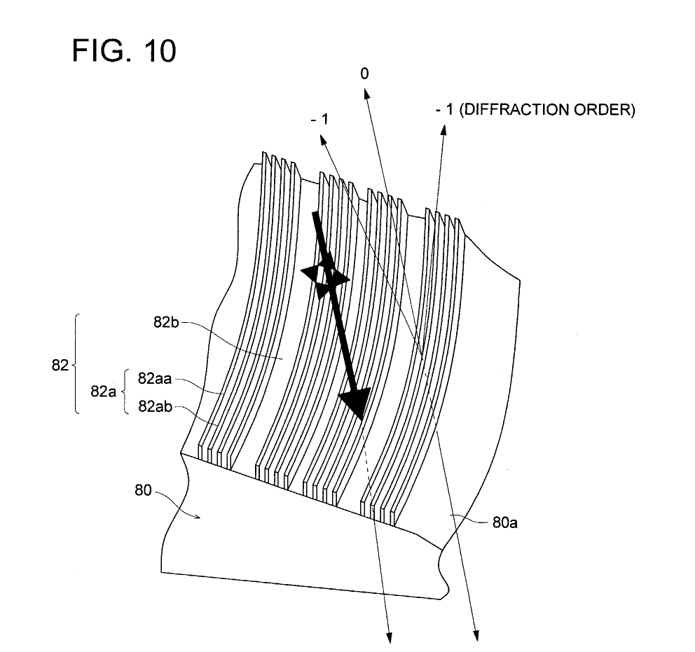

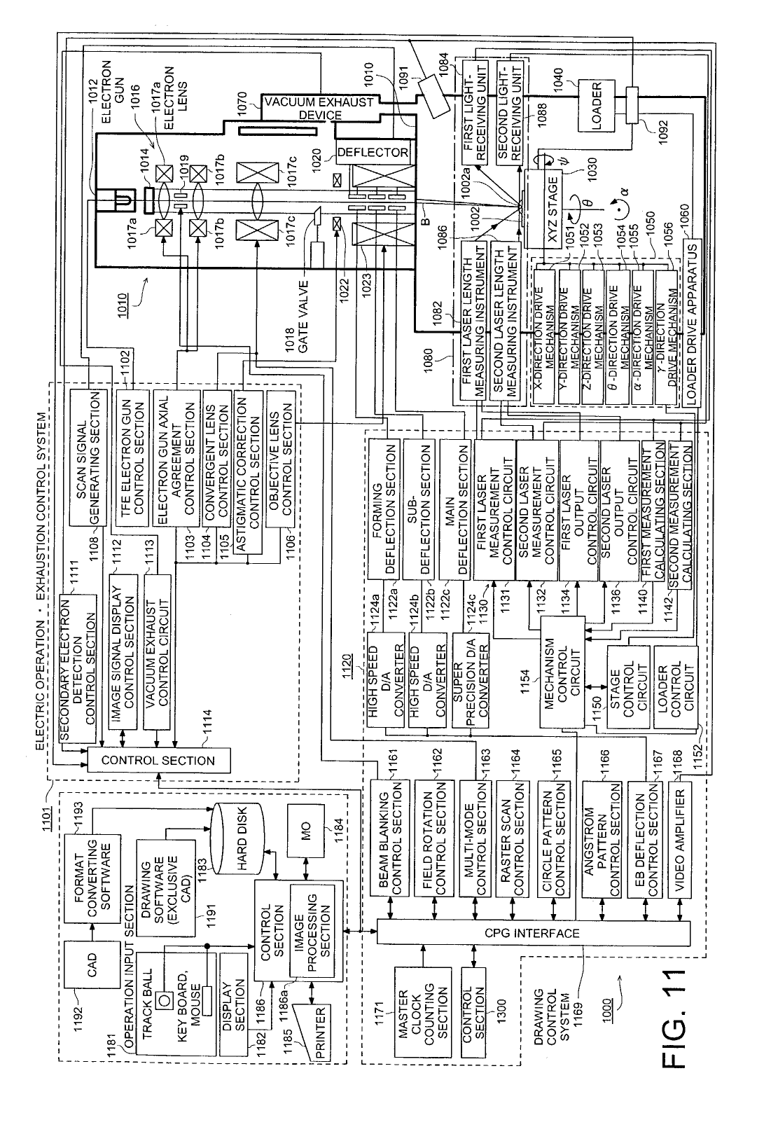

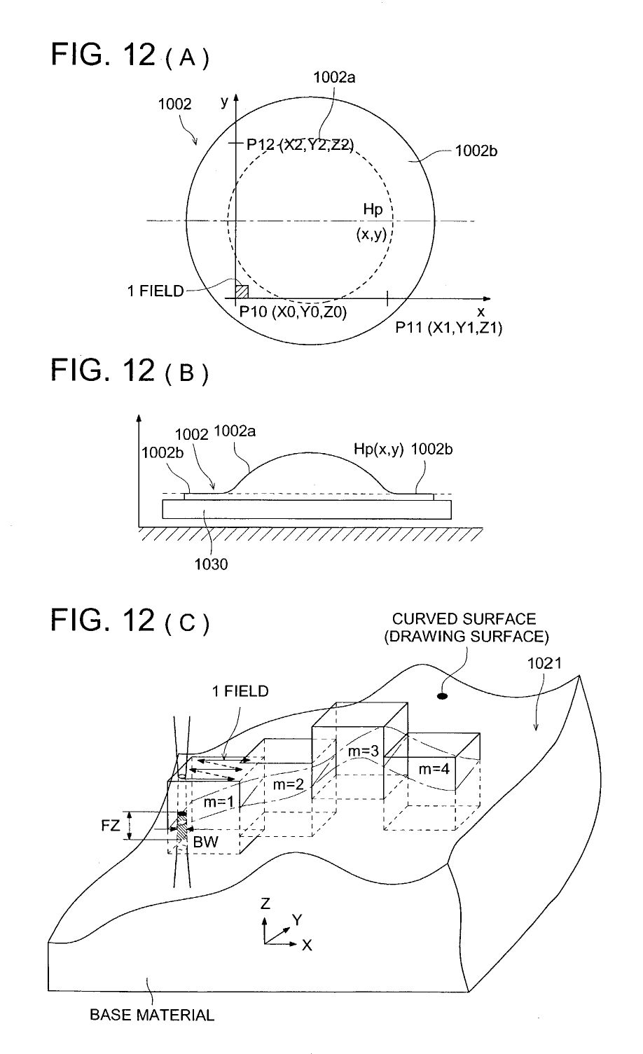

Each of FIGS. 8 and 9 shows results of analyses conducted by a FDTD method for the state of waves of TM wave and TE wave which can be generated by hologram structure 3 in the case of the aforementioned arrangement. In FIG. 8, there is disclosed the state of TE wave generated by the hologram structure 3 and in FIG. 10, on the other hand, there is disclosed the state of TM wave generated by the hologram structure 3.

In these drawings, however, it is assumed that light enters in the direction from the lower portion toward the upper portion in the drawing, and a plane wave that widens infinitely toward the upper side is assumed. Incidentally, the horizontal axis shows a position of hologram structure G2 along the lateral direction (unit×40 nm), and the vertical axis shows a position (unit×40 nm) along the upward direction perpendicular to double refraction phase structure G1. Further, in this drawing, an occasion where wavelength λ is 500 nm is assumed.

As shown in these drawings, when hologram structure 3 (hologram structure G2 in FIGS. 8 and 9) by irregularity in a form shown in FIG. 7(B) is formed, the prescribed polarized light by TM wave A1 and TE wave A2 can be generated properly, as shown in FIGS. 8 and 9. Therefore, it is preferable, from the viewpoint of generating properly 0-th order transmitted light, +first order diffracted light and −first order diffracted light, that p1, p2, t1, t2 and q are set to the numerical values stated above.

However, after all, provided that a function as a hologram structure “to generate 0-th order transmitted light, +first order diffracted light and −first order diffracted light” can be attained, the establishment of dimensions of p1, p2, t1, t2 and q in that structure, or its concaved-convex structure is not naturally limited to the example described above.

By constructing the hologram structure 3 formed by irregularity in the form shown in FIG. 7(B) as stated above, it is possible to polarize and separate light into 0-th order transmitted light, +first order diffracted light and −first order diffracted light.

(Another Embodiment II of a Hologram Structure)

In the simulation stated above, there was assumed an occasion wherein the hologram structure was formed on a plane. In the actual hologram structure, however, hologram structure 82 is formed on curved surface portion 80a of base material 80 as shown in FIG. 10.

The hologram structure 82 is composed of the first concave-convex portion 82a comprising a cyclic structure formed by the first convex portion 82aa and the first concave portion 82ab, and of the second convex portion 82b. By forming the hologram structure on the curved surface portion as stated above, it is possible to diffract light into 0-th order transmitted light, +first order diffracted light and first order diffracted light and to supply light to each portion.

By constructing, in the aforementioned way, a base material (objective lens 2) on which the hologram structure 3 is formed on the surface on one side of the base material and double refraction phase structure 4 is formed on the surface on the other side thereof, laser beam S3 of parallel light from surface 2a on one side of the objective lens 2 is converged by the objective lens 2 to become light S4 in the optical system shown in FIG. 1, for example, and light S1 from surface 2d on the other side that is reflected on the specific position is returned by the objective lens 2 to parallel light.

In this case, laser beam S3 that enters from the surface 2a on one side is transmitted by the hologram structure 3, while, light S1 that enters from the surface 2d on the other side is diffracted by the hologram structure 3 to be polarized into 0-th order transmitted light, −first order diffracted light and +first order diffracted light when emerging through the surface 2a on one side.

Further, laser beam S3 entering through the surface 2a on one side is converged by wavelength plate structure 4 while an oscillation of the laser beam in the specific direction is polarized into that in another specific direction on the plane perpendicular to the advancing direction of the laser beam, while, light S1 reflected on the specific position (magneto-optical recording medium or the like) is changed by the wavelength plate structure 4 to parallel light while its oscillation in the other specific direction is polarized again into the oscillation in the aforesaid specific direction.

Owing to the foregoing, each of 0-th order transmitted light, −first order diffracted light and +first order diffracted light can be utilized in the case of tracking or focusing in an optical pickup device which will be described later.

By drawing a cyclic structure having irregularity in the order of sub-wavelength, in the case of drawing the curved surface portion through 3-dimensional drawing and thereby by forming a hologram structure and a double refraction phase structure on the base material, it is possible to form an optical lens equipped with a hologram structure on one side and with a double refraction phase structure on the other side finally, which may make it possible to apply this to various types of equipment in place of the conventional wavelength plate and hologram plate.

The reason for the foregoing is that elements each having a hologram structure can be manufactured on a mass production basis as a final molded product made through injection molding, by constructing a metal mold based on the base material. Therefore, when there are considered time and labor in each process in forming hologram plates and wavelength plates one by one as in the past, reduction of manufacturing cost and improvement of productivity can be attained sharply.

The hologram structure of this kind and a concrete structure of an electron beam pattern-drawing apparatus that is an assumption for forming a base material having a function of a wavelength plate will be explained as follows.

(Overall Structure of an Electron Beam Pattern-Drawing Apparatus)

Next, an overall schematic structure of an electron beam pattern-drawing apparatus will be explained as follows, referring to FIG. 11 which is an illustration showing an overall structure of the electron beam pattern-drawing apparatus.

Electron beam pattern-drawing apparatus 1000 in the present embodiment is one to form an electron beam probe with high resolution for heavy current as shown in FIG. 11 and to scan base material 102 to be drawn at high speed with an electron beam, and it is structured to include electron gun 1012 representing an electron beam generating means that forms an electron beam probe with high resolution, generates an electron beam and irradiates the beam on a target, slit 1014 that transmits an electron beam generated from the electron gun 1012, electron lens 1016 that controls a focus position of the electron beam passing through the slit 1014 for the base material 1002, gate valve 1018 provided on the path through which the electron beam emerges, coil 1019 for correcting blanking, deflector 1020 that controls a scanning position on base material 1002 representing a target by deflecting the electron beam, electron lens 1022 for conducting astigmatic correction, and objective lens 1023. Incidentally, each of these portions is arranged in lens barrel 1010 and is kept to be under the vacuum state when the electron beam emerges.

With respect to the electron lens 1016, a plurality of electronic lenses are generated by electric current values of respective coils 1017a, 1017b and 1017c which are arranged at plural positions to be apart from each other along the vertical direction, to be controlled, and thus, a focus position of the electron beam is controlled.

Further, the electron beam pattern-drawing apparatus 1000 is structured to include XYZ stage 1030 representing a mounting stand on which base material 1002 to be drawn is placed, loader 1040 representing a conveyance means to convey the base material 1002 to the position of placing on the XYZ stage 1030, measuring apparatus 1080 representing a measuring means to measure a reference point on the surface of the base material 1002 on the XYZ stage 1030, stage drive means 1050 representing a drive means to drive the XYZ stage 1030, loader drive apparatus 1060 to drive the loader, vacuum exhausting apparatus 1070 to exhaust so that the inside of the lens barrel 1010 and the inside of casing 1011 including the XYZ stage 1030 may be vacuumized, second order electron detector 1091 that detects second order electrons, for example, generated based on irradiation of electron beam on the base material 1002 and observes drawing lines, microscopic ammeter 1092 that measures microscopic electric current of the XYZ stage 1030, electric operation exhaustion control system 1101 representing a control means that controls the foregoing, drawing control system 1120, information processing unit 1180 for controlling equipped with various types of computers, and an unillustrated power supply.

Incidentally, it is also possible to provide an observation system such as an electron microscope and to provide an unillustrated other observation optical system, in place of the second order electron detector 91, or it is possible to observe the state of the base material by utilizing these observation system and observation optical system.

The measuring apparatus 1080 is one to detect a height position of base material 1002, and it is structured to include first laser length measuring machine 1082 to the base material 2 by irradiating a laser beam on the base material, first light-receiving portion 1084 wherein a laser beam (first irradiating light) that is emitted from the first laser length measuring machine 1082 and reflected on the base material 1002 is received, second laser length measuring machine 1086 that irradiates at an irradiation angle which is different from that of the first laser length measuring machine 1082, and second light-receiving portion 1088 wherein a laser beam (second irradiating light) that is emitted from the second laser length measuring machine 1086 and is reflected on the base material 1002 is received.

The stage drive means 1050 is composed of X-direction drive mechanism 1051 that drives XYZ stage 1030 in the X-direction, Y-direction drive mechanism 1052 that drives XYZ stage 1030 in the Y-direction, Z-direction drive mechanism 1053 that drives XYZ stage 1030 in the Z-direction, and θ-direction drive mechanism 1053 that drives XYZ stage 1030 in the θ-direction. Incidentally, in addition to the foregoing, it is also possible to provide α-direction drive mechanism 1055 capable of driving to rotate in α-direction on Y axis and φ-direction drive mechanism 1056 capable of driving to rotate in φ-direction on X axis so that the stage may pitch, yaw and roll. Due to this, XYZ stage 1030 may operate in a 3-dimensional way, and alignment may be conducted.

The electric operation exhaustion control system 1101 is structured to include TFE electron gun control section 1102 that adjusts and controls electric current and voltage in an electron gun power supply section that supplies electric power to electron gun 1012, electron gun axis alignment control section 1103 that adjusts and controls each electric current corresponding to each electron lens in a lens power supply section for operating electron lens 1016 (a plurality of electronic lenses) to control axis alignment for the electron gun, converging lens control section 1104 that adjusts and controls each electric current corresponding to each electron lens of electron lens 1016 (a plurality of electronic lenses), astigmatic correction control section 1105 for controlling coil 1022 for astigmatic correction, objective lens control section 1106 for controlling objective lens 1023, scan signal generating section 1108 that generates scan signals in the case of scanning on base material 1002 for detector 1020, secondary electron detection control section 1111 that controls detection signals from secondary electron detector 1091, image signal display control section 1112 that controls for displaying image signals based on detection signals from the secondary electron detection control section 1111, vacuum exhaust control circuit 1113 that controls vacuum exhaustion of vacuum exhausting apparatus 1070 and control section 1114 that controls each section stated above and microscopic ammeter 1092.

Drawing control system 1120 is structured to include molding deflection section 1122a that conducts deflection of a molding direction with deflector 1020, sub-deflection section 1122b that conducts deflection of a sub-scanning direction with deflector 1020, main deflection section 1122c that conducts deflection of a (main) scanning direction with deflector 1020, high speed D/A converter 1124a that converts digital signals into analog signals for controlling the molding deflection section 1122a, high speed D/A converter 1124b that converts digital signals into analog signals for controlling the sub-deflection section 1122b and high speed D/A converter 1124c that converts digital signals into analog signals for controlling the main deflection section 1122c.

Further, the drawing control system 1120 is structured to include first laser measurement control circuit 1131 that controls a movement of a laser irradiation position of first laser length measuring machine 182 and an angle of a laser irradiation angle, second laser measurement control circuit 132 that controls a movement of a laser irradiation position of second laser length measuring machine 1086 and an angle of a laser irradiation angle, first laser output control circuit 1134 for adjusting and controlling output (light intensity of laser) of laser irradiation light by the first laser length measuring machine 82, second laser output control circuit 1136 for adjusting and controlling output of laser irradiation light by the second laser length measuring machine 186, first measurement calculating section 1140 for calculating results of measurement based on results of light-receiving in first light-receiving section 1084, second measurement calculating section 1142 for calculating results of measurement based on results of light-receiving in second light-receiving section 1088, stage control circuit 1150 for controlling state drive means 1050, loader control circuit 1152 for controlling loader drive apparatus 1060 and mechanism control circuit 1154 that controls the aforementioned first and second laser measurement control circuits 1131 and 1132, first and second laser output control circuits 1134 and 1136, first and second measurement calculating sections 1140 and 1142, stage control circuit 1150 and loader control circuit 1152.

Further, the drawing control system 1120 is structured to include beam blank control section 1161 that controls a beam blank representing a blank section from a drawing line to the next drawing line by controlling a value of electric current with coil 1019, field rotation control section 1162 for controlling a drawing field, multi-mode control section 1163 that controls using various types of drawing modes (circle+raster) corresponding to the drawing pattern in combination, raster scan control section 1164 for controlling so that base material 2 may be raster-scanned (scanned) by an electron beam, circle pattern control section 1165 for controlling so that a circle pattern may be drafted, angstrom pattern control section 1166 for controlling so that Angstrom pattern may be drafted, EB deflection control section 1167 that controls various types of deflections, video amplifier 1168 relating to secondary electron detector 1091, master clock count section 1171 for generating and controlling various types of control signals (pulse signals) based on reference clock, control system 1300 that conducts control for converting information coming from information processing unit 1180 into control signal in a form conforming to each section, and CPG interface 1169 that controls input and output of control signals for each section.

The information processing unit 1180 is structured to include operation input section 1158 composed of a key board, a mouse and a track ball for operation-inputting various types of information, display section 1182 such as a monitor for various setting such as switching of mode of drawing for proofing and ordinary drawing described later or mode setting and for the surface state of base material 2 and a cross section image (each section of specific position of a base material) and for a scanning image, and a display capable of indicating various displays such as display of three-dimensional graphic images and display of various software such as simulation of various drawing, hard disk 1183 representing a storage means for storing inputted information, various types of programs such as control programs for conducting various controls, measurement results, correction tables, various types of software and other plural pieces of information, printer 1185 representing an apparatus (having no symbol) capable of reading and writing information recorded on MO 1184 representing an outer recording medium and a printing means capable of printing various pieces of information or an image forming apparatus capable of forming images, and control section 1186 representing a host computer which controls the aforementioned sections.

Further, in electron beam pattern-drawing apparatus 1000 in the present embodiment, it is naturally possible, in the so-called “operation system” or “operation means”, to conduct basic operations such as selection of various types of commands including selection from an analog scan form and a digital scan form and selection from a plurality of drawing patterns each being in a basic form.

It is preferable that the hard disk 1183 (disk apparatus) stores therein, for example, information about drawing patters, drawing software (exclusive CAD) 1191, CAD 1192 representing a software having ordinary 3-dimensional CAD function for designing a drawing pattern and a 3-dimensional form of base material 1002 and format conversion software 1193 for format-converting a file form prepared by CAD 1192, for example, into a file form that can be read by the drawing software 1191. Incidentally, the storage means may also be formed as an area of a storage device such as, for example, a semiconductor memory.

The control section 1186 is structured to include base material 1002 and image processing section 1186b that conducts various image processing for observing and recognizing main scanning on the base material.

The image processing section 1186b receives detection signals from secondary electron detector 1091, for example, and forms image data through secondary electron detection control section 1111 and image signal display control section 1112. It further conducts processing so that images, for example, are displayed on display section 1182 based on image data and position data, for indicating a specific spot. In this case, the image processing section 1186b may also be arranged to be capable of reading data of optional X, Y and Z coordinates from the image data to show three-dimensional images viewed from the desired point of view on the display section 1182. It is also possible to arrange so that image processing such as contour extraction caused by luminance variation is conducted, and a size and a position of distinctive portion on the surface of the base material such as a hole and a line formed by an electron beam are recognized, thereby, whether the base material 1002 is arranged at the desired position by XYZ stage 1030 or not, and whether the hole and the line in a desired size are formed by an electron beam or not can be judged.

The control section 1186 establishes each condition on each section based on instruction of operation inputting section 1181 or on image data. Further, it can control each section for XYZ stage 1030 and electron beam irradiation in accordance with user's instruction inputted from the operation inputting section 1181.

The control section 1186 mentioned above receives all detection signals from secondary electron detector 1091 which have been converted into digital values by secondary electron detector control section 1111. The detection signals vary depending on the position for the electron beam to scan, namely, on the deflection direction of the electron beam. It is therefore possible to detect a form of the surface of a base material in each scanning position of the electron beam, by synchronizing the direction of deflection and the detection signal. By reconstructing these by coping with scanning positions, the control section 1186 can display image data of the surface of the base material on the display section 1182.

In the electron beam pattern-drawing apparatus 1000, when base material 1002 conveyed by loader 1040 is placed on XYZ stage 1030, an electron beam is radiated from electron gun 1012 after air and dust in both of lens barrel 1010 and casing 1011 are exhausted by vacuum exhausting apparatus 1070.

It is preferable that a user specifies condition setting for drawing such as, for example, a drawn field, drawing time and a voltage value, by using, for example, operation input section 1181.

After drawing is started, an electron beam radiated from the electron gun 1012 is deflected by deflector 1020 through electron lens 1016, and the deflected electron beam B (hereinafter a symbol of “electron beam B” is sometimes given only to the electron beam deflected after passing electron lens 1016) is irradiated on the drawing position on the surface of base material 1002 on XYZ stage 1030, for example, on curved surface portion (curved surface) 1002a, and thus, drawing is conducted.

In this case, measuring apparatus 1080 measures a drawing position (at least height position in drawing positions) on base material 1002, or a position of a reference point described later, and electric operation control system 1101 and drawing control system 1120 adjust and control each electric current value flowing through coils 1017a, 1017b and 1017c of electron lens 1016 based on the results of the measurement, to control a position of a focal depth of electron beam B, namely, a focus position, thus, the focus position is controlled to be moved so that it becomes the drawing position.

Or, electric operation control system 1101 and drawing control system 1120 control stage drive means 1050 based on the results of measurement, and thereby move XYZ stage 1030 so that a focus position of the electron beam B may become the drawing position.

Further, in the present example, either one of control of an electron beam and control of XYZ stage 1030 may be used, or both of them may be used.

Then, secondary electron emitted from the surface of base material 2 is detected by scanning, and image processing is conducted by image processing section 1186b based on the results of the detection, and an image showing the surface form of the area is displayed on display section 1182.

Incidentally, as an apparatus, it is also possible to employ the structure wherein drawing by an electron beam and surface observation are conducted simultaneously, and images on a plane that is in parallel with the surface of a base material are obtained in succession to be accumulated as three-dimensional image data, and an optional section is obtained by image conversion, without being limited to the example stated above.

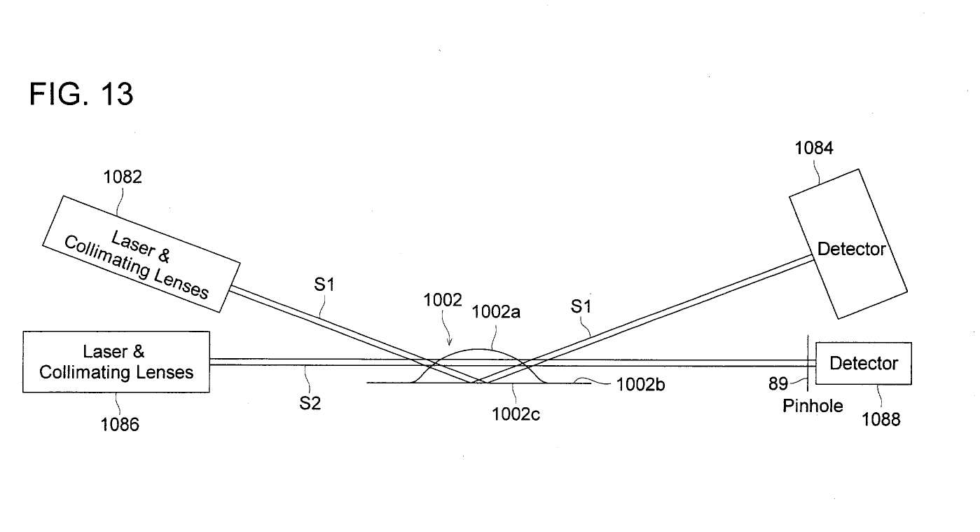

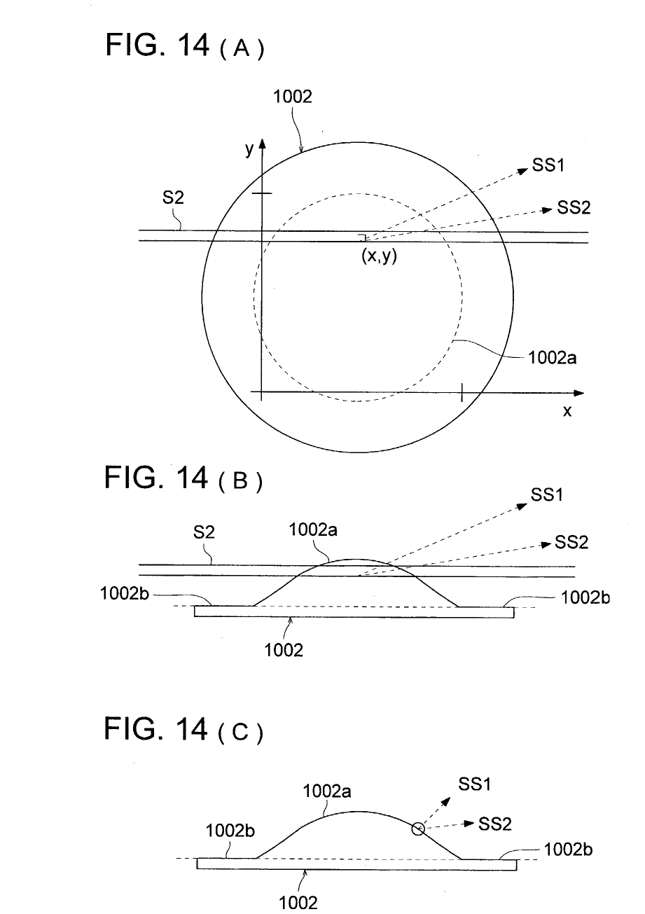

Next, in the measuring apparatus 1080, first laser length measuring machine 1082 applies first light beam S1 on base material 1002 in the direction crossing the electron beam, as shown in FIG. 13, and first light intensity distribution is detected by receiving the first light beam S1 transmitted through the base material 1002.

In this case, since the first light beam S1 is reflected on the bottom portion of the base material 1002, a (height) position on flat portion 1002b of the base material 1002 is measured and calculated based on the first intensity distribution. In this case, however, a (height) position on curved surface portion 1002a of the base material 1002 cannot be measured.

In the present example, therefore, second laser length measuring machine 1086 is further provided. Namely, second laser length measuring machine 1086 applies second light beam S2 on base material 1002 in the direction perpendicular to the electron beam different from the first light beam S1, and second light intensity distribution is detected by receiving the second light beam S2 transmitted through the base material 1002 through second light-receiving section 1088.

In this case, the second light beam S2 is transmitted through curved surface portion 1002a as shown in FIGS. 14(A)-14(C). Therefore, it is possible to measure and calculate a (height) position on the curved surface portion 1002a that is projected from a flat portion of base material 1002, based on the second intensity distribution.

To be concrete, when second light beam S2 is transmitted at the specific height on a certain position (x, y) on curved surface portion 1002a in XY standard coordinates system, the second light beam S2 hits a curved surface of the curved surface portion 1002a at this position (x, y) as shown in FIGS. 14(A)-14(C), to generate scattered light which weakens light intensity by an amount equivalent to a component of the scattered light. In this way, a position can be measured and calculated based on the second light intensity distribution detected by second light-receiving section 1088.

Then, a focus position of the electron beam is adjusted based on this position of the height of the base material which serves, for example, as a drawing position, and drawing is conducted.

(Outline of a Principle of Drawing Position Calculation)

Next, an outline of the principle for drawing on electron beam pattern-drawing apparatus 1000 will be explained.

First, base material 1002 is preferably formed by an optical element such as an optical lens made of resin, for example, as shown in FIGS. 12(A) and 12(B), and it is structured to include flat portion 1002b whose sectional view is almost in a form of a flat plate and curved surface portion 1002a that is protruded from the flat portion 1002b and is formed to be a curved surface. The curved surface of this curved surface portion 1002a may also be a free curved surface having variation in all heights such as an aspheric surface, without being limited to a spherical surface.

In the base material 1002 of this kind, plural reference points, for example, three reference points P01, P02 and P03 on the base material 1002 are determined and their positions are measured (measurement A) in advance before the base material 1002 is placed on XYZ stage 1030. Due to this, an X axis is defined by, for example, reference points P00 and P01 and a Y axis is defined by reference points P00 and P02, and a first standard coordinates system in a three-dimensional coordinates system is calculated. Now, let it be assumed that a height position in the first standard coordinates system is represented by Ho (x, y) (first height position). Owing to this, thickness distribution of base material 2 can be calculated.

On the other hand, even after the base material 1002 is placed on the XYZ stage 1030, the same processing as in the foregoing is conducted. Namely, plural reference points, for example, three reference points P10, P11 and P12 on the base material 1002 are determined and their positions are measured (measurement B) as shown in FIG. 12(A). Due to this, an X axis is defined by, for example, reference points P10 and P11 and a Y axis is defined by reference points P10 and P12, and a second standard coordinates system in a three-dimensional coordinates system is calculated.

Further, a coordinate transformation matrix for converting the first standard coordinates system into the second standard coordinates system is calculated by these reference points P00, P01, P02, P10, P11 and P12, and by using this coordinate transformation matrix, height position Hp (x, y) (second height position) corresponding to the aforementioned Ho (x, y) in the second standard coordinates system is calculated, and this position is made to be an optimum focus position, namely, a position where the focus of the electron beam is taken as a drawing position. Due to this, distribution of thickness of the base material 1002 can be corrected.

Incidentally, the measurement B may be carried out by the use of measuring apparatus 1080 representing a measuring means of electron beam pattern-drawing apparatus 1000.

It is necessary that the measurement A is carried out in advance by the use of another measuring apparatus at a different place. As a measuring apparatus for measuring reference points in advance before placing the base material 1002 on the XYZ stage 1030 as in the foregoing, it is possible to employ a measuring apparatus having the structure that is exactly the same as that of the aforementioned measuring apparatus 1080.

In this case, results of the measurement are subjected to data-transmission through an unillustrated network, to be stored in memory hard disk 1183. There may naturally be considered an occasion where the measuring apparatus is not necessary.

A drawing position is calculated in the way stated above, and a focus position of the electron beam is controlled, thus, drawing is conducted.

Specifically, a focus position of focal depth FZ (beam waist BW) of the electron beam is controlled to be adjusted to the drawing position within one field (m=1) of a unit space in the three-dimensional standard coordinates system, as shown in FIG. 12(C). (This control is conducted by either one of adjustment of an electric current value by electron lens 1016 and drive control of XYZ stage 1030, or by both of them.) Incidentally, in the present example, a field is set so that a component of a height of one field is longer than focal depth FZ, to which, however, the invention is not limited. The focal depth FZ in this case means a height in the range where beam waist BW is effective in the electron beam radiated through an electron lens.

Incidentally, in the case of electron beam B, when D represents a width of an electron lens and f represents a depth from the electron lens to beam waist (a location where a beam diameter is smallest) BW, D/f is about 0.01, resolution of the lens is about 50 nm, for example, and a focal depth of the lens is about several tens μ, for example.

By scanning in the X direction while shifting in the Y direction in one field, for example, as shown in FIG. 12(C), there is conducted drawing within one field. Further, if there is a field which is not drafted, within one field, that field is moved in the Z direction while conducting aforesaid control of the focus position and is subjected to drawing by the same scanning.

Next, after drawing within one field, drawing is conducted on a real time basis while conducting measurement and calculation of the drawing position in the same way as in the foregoing, even for other fields, for example, a field of m−2, and a field of m=3. With completion of all drawing operations on the areas to be drawn, drawing processing on the surface of base material 1002 is terminated. Incidentally, in the example, a portion corresponding to a curved surface on the surface of the curved surface portion on an area to be drawn is made to be an pattern-drawn field.

Further, processing programs which conduct various types of operation processing, measurement processing and control processing are stored in hard disk 1183 as a control program in advance.

Hard disk 1183 of electron beam pattern-drawing apparatus 1100 has therein a shape-memory table, and this shape-memory table has therein dose distribution information concerning characteristics of dose distribution wherein information of distribution of dose amount for scanning position in the course of forming for each pitch by inclining a diffraction grating on curved surface portion 1002a of base material 1002, for example, dose distribution information concerning dose amount of concave-convex portion in the course of forming irregularity for prevention of surface reflection for each pitch, dose distribution correction operating information resulted after correction operation for dose distribution,

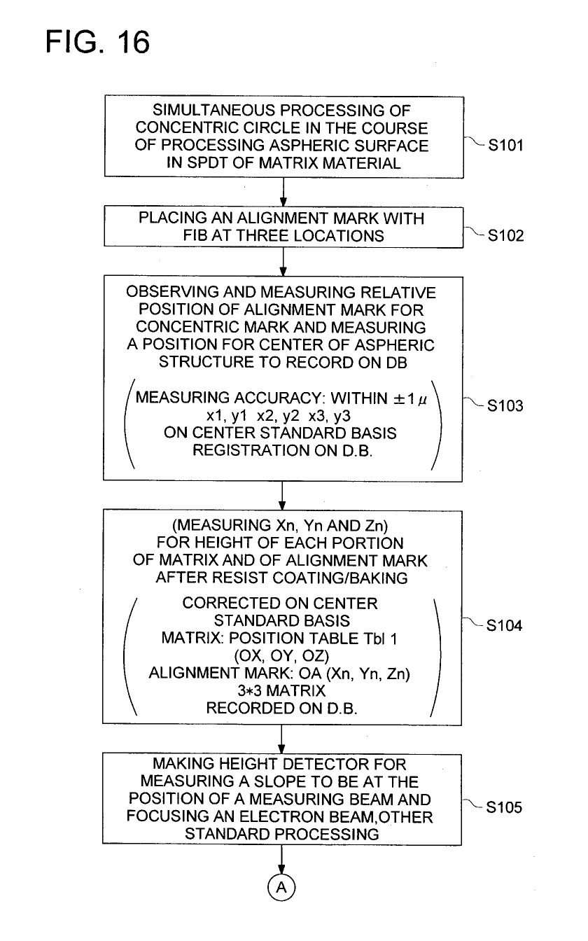

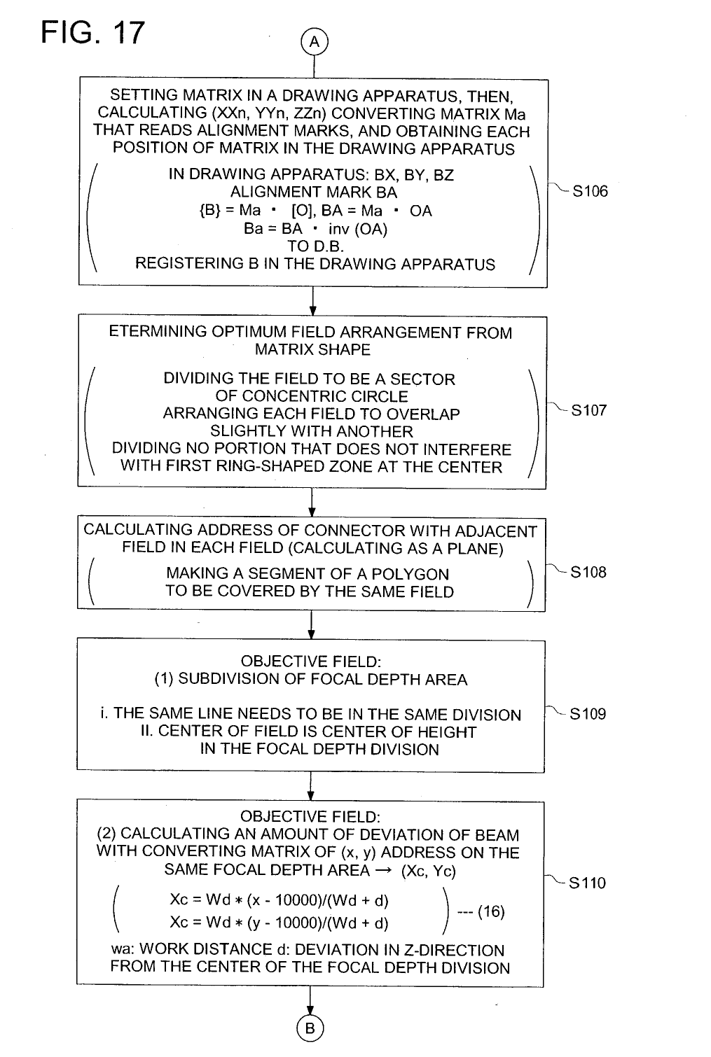

other information, processing programs for conducting the aforesaid processing (n a more detailed way, for example, a series of processing of S101-S118 in FIGS. 16-18 which will be described later), dose distribution operation program for calculating dose distribution characteristics with operation in prescribed inclination angle on the curved surface portion based on information such as the dose distribution information and dose distribution correction operation information, and other processing programs.

In the control system having the structure of this kind, dose distribution information is stored in a shape-memory table of hard disk 1183 in advance, and the dose distribution information is extracted in the course of drawing, based on processing program, and various types of drawing are conducted by the dose distribution information.

Incidentally, the storage means in the invention can be structured by the hard disk of the present embodiment, and “control means” in the invention can be structured by the control section, a drawing control system, electric operations and exhaustion control system.

This control means adjusts electric current values of the electron lens based on the drawing position measured by the measuring means, and controls variably the focus position of the electron beam to control so that drawing on a curved surface portion of the base material and on a hologram structure portion may be conducted.

Further, the control means adjusts electric current values of the electron lens based on the drawing position measured by the measuring means, and controls variably the focus position of the electron beam to control so that drawing on a curved surface portion of the base material and on a double refraction phase structure portion may be conducted.

Further, based on the drawing position measured by the measuring means, the mounting stand is lifted and lowered by the drive means, and the focus position of the electron beam radiated by the electron beam radiating means is controlled variably according to the drawing position, to control so that drawing on a curved surface portion of the base material and on a double refraction phase structure portion may be conducted.

In addition, when the measuring means measures a drawing position to be drawn on the first base material when a hologram structure is formed on the first base material, and when the measuring means measures a drawing position to be drawn on the second base material when a double refraction phase structure is formed on the second base material, the storage means stores characteristics of dose distribution; in the dose distribution, dose amount distribution for the scanning position in which a dose amount of each pitch portion of diffraction grating inclined according to inclination position on the curved surface portion is considered is defined in advance.

In this case, the control means adjusts electric current values of the electron lens based on the drawing position measured by the measuring means, when drawing a curved surface portion and a hologram structure on the first base material, and controls variably the focus position of the electron beam according to the drawing position, and adjusts electric current values of the electron lens based on the drawing position measured by the measuring means, when drawing a curved surface portion and a double refraction phase structure on the second base material, and controls variably the focus position of the electron beam according to the drawing position, and controls to draft a curved surface portion and a double refraction phase structure portion on the base material while calculating the dose amount, based on characteristics of the dose distribution of the storage means concerning the inside of the focal depth at the focus position. Due to this, the first base material and the second base material are drafted independently, and one base material is generated from the first and second base materials after the step of drawing.

Further, when the measuring means measures a drawing position to be drawn on the first base material when a hologram structure is formed on the first base material, and when the measuring means measures a drawing position to be drawn on the second base material when a diffraction grating structure is formed on the second base material, the storage means stores characteristics of dose distribution; in the dose distribution, dose amount distribution for the scanning position in which a dose amount of each pitch portion of diffraction grating inclined according to inclination position on the curved surface portion is considered is defined in advance.

In this case, the control means adjusts electric current values of the electron lens based on the drawing position measured by the measuring means, when drawing a curved surface portion and a hologram structure on the first base material, and controls variably the focus position of the electron beam according to the drawing position, and adjusts electric current values of the electron lens based on the drawing position measured by the measuring means, when drawing a curved surface portion and a diffraction grating structure on the second base material, and controls variably the focus position of the electron beam according to the drawing position, and controls to draft a curved surface portion and a diffraction grating structure portion on the base material while calculating the dose amount, based on characteristics of the dose distribution of the storage means concerning the inside of the focal depth at the focus position. Due to this, the first base material and the second base material are drafted independently, and one base material is generated from the first and second base materials after the step of drawing.

(Structures of Other Control Systems)

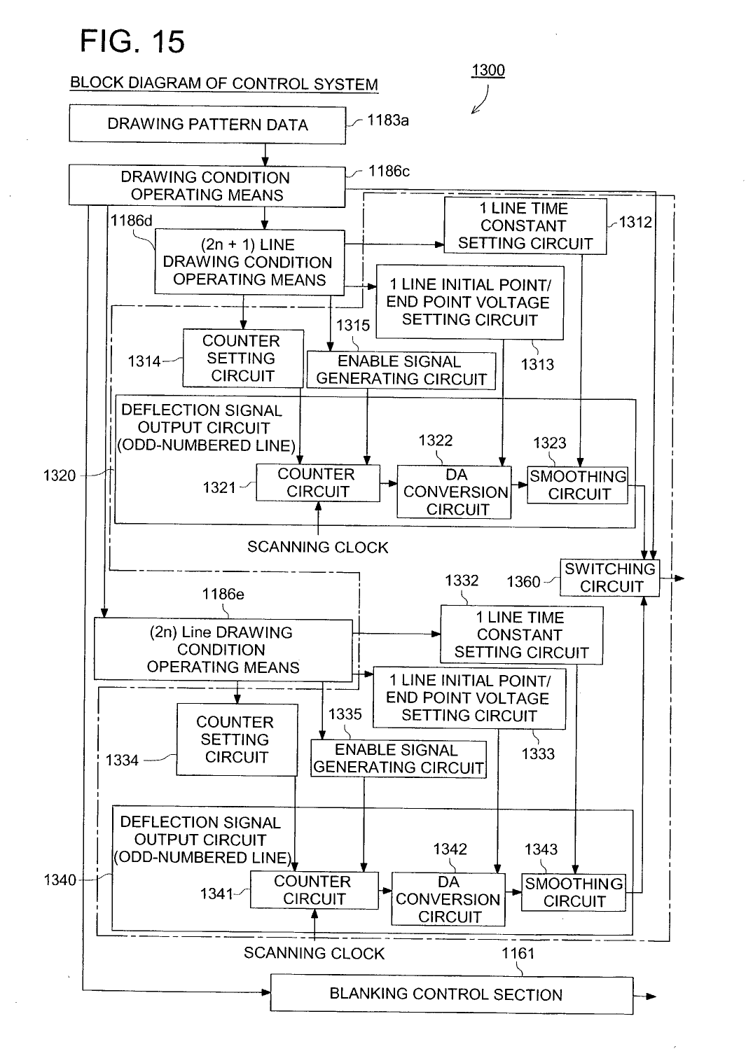

Next, by referring to FIG. 15, there will be explained an concrete structure of the control system for conducting various processing in the case of scanning linearly by making the circular drawing to approximate to a regular polygon, for example, when drawing a drawing line. FIG. 15 discloses a detailed structure of the control system of the electron beam pattern-drawing apparatus in the present embodiment.

As shown in FIG. 15, in the electron beam pattern-drawing apparatus, there are provided drawing pattern data 1183a representing a drawing pattern storage means that stores various data (corresponding to radiuses of circles) necessary for approximating to a regular polygon (including irregular polygon) when drawing the circle (for example, information about each circle including the number of division for the polygon about a circle whose radius is k mm, a position of each side, coordinates information of each position, a value of a multiple of clock number and a position in the Z direction), various data necessary for approximating linearly when drawing various curved lines in addition to drawing of a circle, and data concerning various drawing patterns (a rectangle, a triangle, a polygon, a longitudinal line, a lateral line, an oblique line, a disk, a circumference of a circle, a three-cornered circumference, a circular arc, a sector and an ellipse), drawing condition operation means 1186c that conducts operations of drawing conditions based on drawing pattern data of the drawing pattern data 1183a, (2n+1) line drawing condition operation means 1186d that operates, from the drawing condition operation means 1186c, drawing conditions for (2n+1) line (which may also be (2n−1) in the case of (n=1, 2, . . . ) although is (2n+1) in the case of (n=0, 1, 2 . . . )), namely, for an odd number line, and (2n) line drawing condition operation means 1186e that operates, from the drawing condition operation means 1186c, drawing conditions for (2n) line, namely, for an even number line.

Incidentally, it is preferable that drawing pattern data 1183a are incorporated in hard disk 1183, and drawing condition operation means 1186c, (2n+1) line drawing condition operation means 1186d and (2n) line drawing condition operation means 1186e are incorporated in control section 1186.

As shown in FIG. 15, control system 1300 for the electron beam pattern-drawing apparatus is structured to include time constant setting circuit 1312 that sets time constant of one line based on the (2n+1) line drawing condition operation means 1186d, start point/end point voltage setting circuit 1313 that sets voltage at start point and end point of one line based on the (2n+1) line drawing condition operation means 1186d, counter number setting circuit 1314 that sets the counter number based on the (2n+1) line drawing condition operation means 1186d, enable signal generating circuit 1315 that generates enable signals based on the (2n+1) line drawing condition operation means 1186d, and deflection signal output circuit 1320 for outputting deflection signals of an odd number line.

The control system 1300 is further structured to include time constant setting circuit 1332 that sets time constant of one line based on the (2n) line drawing condition operation means 1186e, start point/end point voltage setting circuit 1333 that sets voltage at start point and end point of one line based on the (2n) line drawing condition operation means 1186e, counter number setting circuit 1334 that sets the counter number based on the (2n) line drawing condition operation means 1186e, enable signal generating circuit 1335 that generates enable signals based on the (2n) line drawing condition operation means 1186e, deflection signal output circuit 1340 for outputting deflection signals of an even number line and switching circuit 1360 that switches between processing of an odd number line and processing of an even number line based on drawing conditions at drawing condition operation means 1186a and on information from deflection signal output circuit 1320 for an odd number line and from deflection signal output circuit 1340 for an even number line.

The deflection signal output circuit 1320 for an odd number line is structured to include counter circuit 1321 representing a counting means that conducts counting processing based on scanning clock, odd number line count signals coming from counter number setting circuit 314 and on enable signals of enable signal generating circuit 1315, DA conversion circuit 1322 that conducts DA conversion based on count timing coming from counter circuit 1321 and on odd number line drawing condition signals at start point/end point voltage setting circuit 1313, and smoothing circuit 1323 that conducts processing (processing for removing high frequency components of deflection signals) to smooth analog signals converted by the DA conversion circuit 1322.

The deflection signal output circuit 1340 for an even number line is structured to include counter circuit 1324 representing a counting means that conducts counting processing based on scanning clock, odd number line count signals coming from counter number setting circuit 1334 and on enable signals of enable signal generating circuit 1335, DA conversion circuit 1342 that conducts DA conversion based on count timing coming from counter circuit 1341 and on even number line drawing condition signals at start point/end point voltage setting circuit 1333, and smoothing circuit 1343 that conducts processing to smooth analog signals converted by the DA conversion circuit 1342.

These control systems 1300 may also be of the structure forming a control system for X deflection and for Y deflection.

The control systems 1300 having the aforementioned structure operates roughly as follows. Namely, when drawing condition operation means 1186c acquires, from drawing pattern data 1183a, information necessary for scanning (drawing) by straight line approximation, operation processing of a prescribed drawing condition is conducted, and information about a first side among sides in the case of approximation of one circle and about an odd-numbered line is transmitted to (2n+1) line drawing condition operation means 186d, and information about the next side and about the even-numbered line is transmitted to (2n) line drawing condition operation means 186e.

Owing to this, (2n+1) line drawing condition operation means 1186d, for example, generates drawing conditions concerning odd number lines, and outputs odd number line deflection signals from deflection signal output circuit 1320, based on scanning clock and on generated odd number line drawing condition generating signals.

On the other hand, (2n) line drawing condition operation means 1186e, for example, generates drawing conditions relating to even number lines, and outputs even number line deflection signals from deflection signal output circuit 1340, based on scanning clock and on generated even number line drawing condition generating signals.

These odd number line deflection signals and even number line deflection signals are switched alternately in terms of output by switching circuit 1360 under drawing condition operation means 1186c. Therefore, when a circle is made to approximate to a regular polygon and each side of the polygon is calculated, a certain side which is an odd-numbered side is drafted, then, the next side which is an even-numbered side is drafted and further, the next side which is an odd-numbered side is drafted, thus, each side is drafted (scanned) linearly alternately.

Then, when drawing is completed for a certain circle, drawing condition operation means 1186c transmits to blanking control section 1161 to that effect, and conducts processing to urge drawing for another circle that follows. In this way, each circle approximating to a polygon is subjected to drawing.

In this way, drawing on the first base material is conducted by scanning the first base material to be drawn by an electron beam with the electron beam to form a curved surface portion on one surface of the first base material, and drawing lines which have a sectional view that is almost in a concave-convex form and become a hologram structure are drafted on the curved surface portion by conducting positional adjustment in the direction of height by relative movement of focus position of the electron beam for the first base material, while conducting positional adjustment in the direction of a plane.

Further, drawing on the second base material is conducted by scanning the second base material to be drawn by an electron beam with the electron beam to form a curved surface portion on one surface of the second base material, and drawing lines which have a sectional view that is almost in a concave-convex form to be of a diffraction grating structure and become a wavelength plate structure (double refraction phase structure) are drafted on the curved surface portion by conducting positional adjustment in the direction of height by relative movement of focus position of the electron beam for the first base material, while conducting positional adjustment in the direction of a plane.

Due to this, it is possible to conduct drawing for each of the first and second base materials independently to generate the first and second base materials as one base material in the process after the drawing. Incidentally, this also applies to the occasion where a hologram structure is formed on the first base material and a diffraction grating structure is formed on the second base material.

(Processing Procedures)

Next, there will be explained, with reference to FIGS. 16-18, the processing procedures for preparing a base material having the above-mentioned structure by using an electron beam pattern-drawing apparatus capable of drawing on a three-dimensional basis.

First, when conducting processing of an aspheric surface on a matrix material (base material) through SPDT (Single Point Diamond Turning: turning with diamond on a super precision processing machine), simultaneous processing of concentric circles is conducted (step, hereinafter referred to as “S” 101). In this case, it is preferable that a form with detection accuracy within ±1μ, for example, is formed under the condition of an optical microscope.

Next, alignment marks are put at three locations, for example, with FIB (S 102). In this case, it is preferable that a cross-shaped alignment mark has detection accuracy of ±20 nm or less in an electron beam pattern-drawing apparatus.

Further, a relative position of the alignment mark to a mark of concentric circles is observed under the optical microscope, then a position to the center of the aspheric structure is measured to be recorded in a data base (DB) (or a memory (hereinafter, the same)) (S 103). Incidentally, the measurement accuracy is preferably ±1μ or less, and positions of three alignment marks which are made to be center standards, x1y1, x2y2 and x3y3 are registered in data base (DB).

Further, a height of each section of matrix (base material) after resist coating/baking and positions (Xn, Yn and Zn) of alignment marks are measured (S 104). In this case, matrix (base material) corrected by the center standard, position table Tb 11 (OX, OY and OZ) and alignment marks, and OA (Xn, Yn and Zn) (any of them is 3*3 matrix) are registered in a data base (DB).

Next, other various types of preparation processing including focusing of an electron beam on a position of a measurement beam of a measuring apparatus (height detector) for measurement of a slope are conducted (S 105).

In this case, a measurement beam for detecting a height is irradiated on an acicular corrector for EB (electron beam) focusing that is mounted on a stage, and it is observed by an electron beam pattern-drawing apparatus under SEM mode to adjust the focus.

Then, the matrix (base material) is set in the electron beam pattern-drawing apparatus, and alignment marks are read (XXn, YYn and ZZn) (S 106). Inside the electron beam pattern-drawing apparatus, in this case, each value shown in S 106 is registered in the data base (DB).

Further, an optimum field position is determined from a form of the matrix (base material) (S 107). With respect to the field, each field divided into a sector with concentric circles to be distributed is overlapped with others slightly. There is no field distribution in the first ring-shaped zone at the center.

For each field, an address for linkage with a neighboring field is calculated (S 108). This calculation is made as a plane. Incidentally, one segment of a line of a polygon is confined in the same field. “Polygon” in this case means at least one drawing line in the case where a circle for drawing is approximated to a prescribed n-gon, as explained in the item of the aforesaid control system.

Next, with respect to the aimed field, the same line is confined in the same division as a division of a focal depth area. Further, a center of the field is made to be a height center of the focal depth division (S 109). In this case, height 50μ or less is made to be a range of the same focal depth.

Then, with respect to the aimed field, conversion matrix (Xc, Yc) of (x, y) address in the same focal depth area is calculated (S 110). This Xc and Yc are respectively those shown by illustrated expression (16).

Further, with respect to the aimed field, an address for linkage with a neighboring field is converted (S 111). Here, the linkage position calculated in S 108 is converted by using expression (16) in S 110.

Then, with respect to the aimed field, XYZ stage is moved to the center to set a height at the focus position of EB (electron beam) (S 112). Namely, setting is made to the field center with the XYZ stage. In addition, the XYZ stage is moved while detecting the signal of a measuring apparatus (height detector), and a height position is read.

Further, with respect to the aimed field, a height center of the area in the same focal depth on the outermost side (m-th) and a focus position of an electron beam (EB) are made to agree with each other (S 113). Specifically, XYZ stage is moved by a prescribed amount that is an amount equivalent to a difference from a height position on the field center.

Next, with respect to the aimed inside of the same focal depth, a dose amount of outermost (n-th) line, a start point and an end point of a polygon are calculated (S 114). Then, line drawing is conducted at a constant dose (S 115). Then, operations from S 113 to S 115 are conducted for prescribed number of times (S 116).

Next, a movement of XYZ stage and preparation for conducting drawing of the succeeding field are conducted (S 117). In this case, field number, time and temperature are registered in data base (DB).

By conducting operations from S 109 to S 117 for prescribed number of times in the above-mentioned way (S 118), it is possible to form a base material having a polarized light separating structure on a curved surface portion or a base material having a double refraction phase structure on a curved surface portion with electron beam.

In the present embodiment, it is possible to form an optical lens equipped with a hologram structure on an entire surface finally, by drawing a cyclic structure by irregularity in a sub-wavelength order and by forming a hologram structure on the base material, synchronizing with an occasion for drawing a curved surface portion by drawing on a three-dimensional basis. Therefore, it may be possible to apply this to various equipment, in place of conventional hologram plates.

The reason for the foregoing is that the element having the hologram structure can be manufactured successively on a mass production basis as a final molding made through injection molding. It is therefore possible to achieve sharp reduction of manufacturing cost and improvement of productivity, when labor and time in each process for forming hologram plates one by one in the past are taken into consideration.

Further, by molding a double refraction phase structure on the base material, an optical lens equipped with a wavelength plate function representing a double refraction phase structure on entire surface can be formed finally. Therefore, it may be possible to apply this to various equipment, in place of conventional wavelength plates.

The reason for the foregoing is that the element having the wavelength plate function can be manufactured successively on a mass production basis as a final molding made through injection molding. It is therefore possible to achieve sharp reduction of manufacturing cost and improvement of productivity, when labor and time in each process for forming wavelength plates one by one in the past are taken into consideration.

### Second Embodiment

Next, the second embodiment of the invention will be explained based on FIGS. 19-21. Incidentally, an explanation of the structure which is substantially the same as that of the first embodiment will be omitted, and different points only will be explained.

In the first embodiment stated above, a process to conduct precision work such as a hologram construction on a base material by an electron beam was disclosed. However, in the present embodiment, there will be explained a total process including the aforementioned process, in particular, a process to make a metal mold for manufacturing an optical lens such as an optical element through injection molding.

(Process to Make a Metal Mold Having a Hologram Structure)

First, an aspheric surface of a metal mold (electroless nickel) is processed through mechanical processing (working process). Next, resin molding for base material 200 having the hemispherical surface is conducted by a metal mold as shown in FIG. 19(A) (resin molding process). Further, the base material 200 is washed and dried.

Then, surface treatment is conducted on the resin base material 200 (resin surface treatment process). Specifically, the base material 200 is positioned, and a spinner is rotated while resist L representing a coating agent drops for conducting spin coating, as shown in FIG. 19(B). Further, prebaking is also conducted.

After the spin coating, a thickness of a film of the resist is measured to evaluate the resist film (resist film evaluation process). Then, the base material 200 is positioned as shown in FIG. 19(C), and drawing of the curved surface portion having hologram structure 202 is conducted by three-dimensional electron beam while the base material 200 is controlled respectively by X, Y and Z axes, as in the first embodiment (drawing process).

Next, surface smoothing treatment is conducted on resist film L on the base material 200 (surface smoothing process). Further, photographic processing is conducted while the base material 200 is positioned as shown in FIG. 19(D) (development process) Further, surface hardening processing is conducted.

Then, there is conducted a process to evaluate a form of resist through SEM observation and a film thickness measuring apparatus (resist form evaluation process). After that, etching processing is further conducted through dry etching.

In this case, in the drawing where J portion of hologram structure 202 is enlarged, convex portion 202a and concave portion 202b are provided, and in the drawing where F portion is enlarged, the hologram structure 202 has therein convex portion 202a having the first width dl and concave portion 202b having the second width d2 which is different from the first width d1, and a plurality of them are formed to be placed at intervals.

Next, to make metal mold 204 for surface-treated base material 200, electroforming processing is conducted after conducting metal mold preliminary electroforming as shown in FIG. 20(A), and processing to separate the base material 200 from the metal mold 204 is conducted as shown in FIG. 20(B).

Surface treatment is conducted on the metal mold 204 separated from the base material which has been subjected to surface treatment (metal mold surface treatment). Then, the metal mold 204 is evaluated.

In this case, on the metal mold 204, there is formed structure 205 composed of concave portion 205a and convex portion 205b both corresponding respectively to the convex portion and the concave portion of the base material 200 which are shown in the enlarged drawing of K portion.

(Process to Make a Metal Mold Having a Double Refraction Phase Structure)

Next, a metal mold for manufacturing a base material having a function of a wavelength plate representing a double refraction phase structure is made in the same way as in the occasion to form the hologram structure.

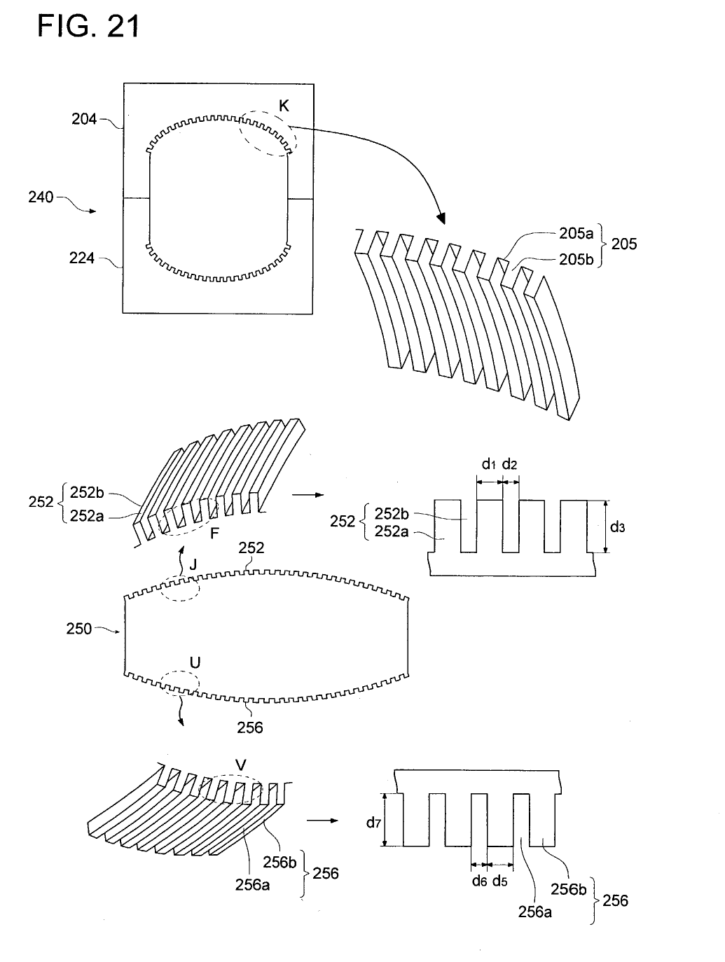

Then, as shown in FIG. 21, injection molding is conducted after the metal mold 204 capable of forming a hologram structure on a curved surface portion and metal mold 224 capable of forming a double refraction phase structure on a curved surface portion are arranged to face each other.

In this case, on metal mold 204 on one side, there is formed structure 205 composed of concave portion 205a and convex portion 205b both corresponding respectively to the convex portion and the concave portion on the base material which is set in terms of dimensions to function as a hologram structure, which are shown in the enlarged drawing of K portion.

On metal mold 224 on the other side, there is formed a structure composed of a concave portion and a convex portion both corresponding respectively to a convex portion and a concave portion on a base material which is set in terms of dimensions to function as a double refraction phase structure.

In the method stated above, a molding is made through injection molding as shown in FIG. 21 by the use of the metal molds 224 and 204, after evaluation. After that, the molding is evaluated.

In this case, a structure identical to that of the base material of the first embodiment is finished on injection molding 250 as shown in FIG. 21, and hologram structure 252 composed of plural asymmetric irregularity is formed on the curved surface portion on one side. In the enlarged drawing of J portion, convex portion 252a and concave portion 252b are provided, and in the enlarged drawing of F portion, the hologram structure 252 has therein convex portion 252a having the first width d1 and concave portion 252b having the second width d2 which is different from the first width dl, and a plurality of them are formed to be placed at intervals.

In addition, double refraction phase structure 256 composed of plural irregularity is formed on the curved surface portion on the other side. The drawing where U portion is enlarged shows a cyclic structure that is formed when convex portion 256a having the first width d5 and concave portion 256b having the second width d6 that is shorter than the first width d5 are positioned alternately. Incidentally, let it be assumed that a height of the convex portion 256a is formed by d7.

In the present embodiment, when forming an optical element (for example, a lens) as a base material of the first embodiment, a hologram structure composed of irregularity in sub-wavelength order is drafted in synchronization with drawing of a curved surface on a three-dimensional pattern-drawing apparatus, so that the hologram structure may be formed as a form of a metal mold, and thereby, the optical element can be manufactured through injection molding by the use of a metal mold, which makes it possible to achieve reduction of manufacturing cost.

Further, by adding a structure having a hologram function as a metal mold, it is possible to add functions simultaneously when molding a lens through injection molding, and no addition of process is required. Therefore, it is possible to achieve sharp reduction of cost and reduction of man-hours, compared with an occasion wherein a base material such as a polarized beam splitter representing a hologram plate is processed one by one as in the past, although there are cost increase of a metal mold itself and an increase in the number of shots (approximately, a million times).

Since it is further possible to fabricate a hologram structure simultaneously in a course of injection molding of a plastic lens, no process of making polarized light separating element is required, which leads to low cost of optical parts.

In particular, it is also possible to apply to the lens which has no curved surface portion structure and is made through injection molding, and various types of steps cab be eliminated, which makes it possible to realize sharp reduction of cost.

In addition, when forming an optical element (for example, a lens) as a base material of the first embodiment, a double refraction phase structure composed of irregularity in sub-wavelength order is drafted in synchronization with drawing of a curved surface portion on a three-dimensional pattern-drawing apparatus, so that the double refraction phase structure may be formed as a form of a metal mold, and thereby, the optical element can be manufactured through injection molding by the use of a metal mold, which makes it possible to achieve reduction of manufacturing cost.

Further, by adding a structure having a wavelength plate function as a metal mold, it is possible to add functions simultaneously when molding a lens through injection molding, and no addition of process is required. Therefore, it is possible to achieve sharp reduction of cost and reduction of man-hours, compared with an occasion wherein a base material such as a polarized beam splitter representing a wavelength plate is processed one by one as in the past, although there exist cost increase of a metal mold itself and an increase in the number of shots (approximately, a million times).

Since it is further possible to fabricate a wavelength plate function simultaneously in a course of injection molding of a plastic lens, no process of making a wavelength plate is required, which leads to low cost of optical parts.

In particular, it is also possible to apply to the lens which has no curved surface portion structure and is made through injection molding, and various types of steps cab be eliminated, which makes it possible to realize sharp reduction of cost.

### Third Embodiment

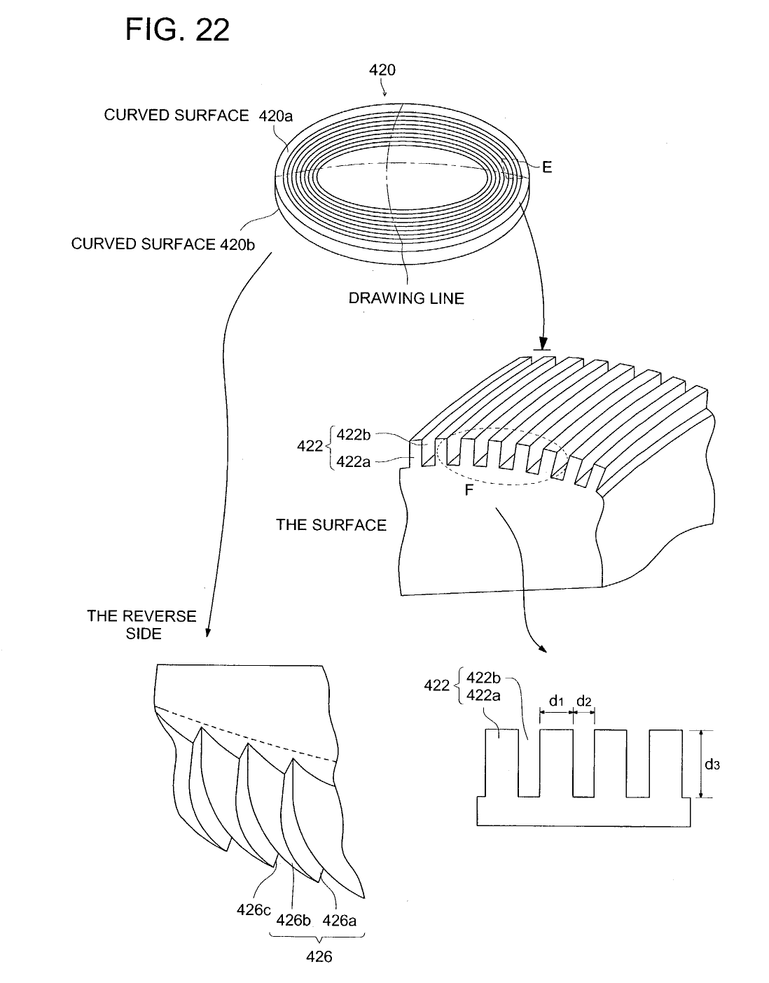

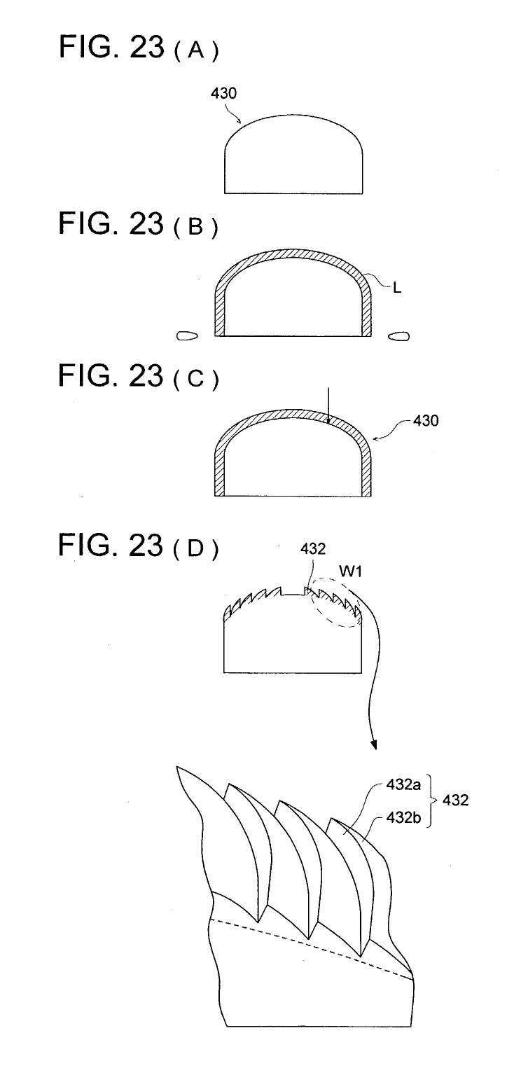

Next, the third embodiment of the invention will be explained based on FIG. 22.

In the embodiment stated above, there was explained the optical element wherein a hologram structure representing a diffraction grating structure composed of irregularity of a binary pattern is formed on a curved surface portion on one side, and a double refraction phase structure representing a diffraction grating structure composed of irregularity of a binary pattern is formed on a curved surface portion on the other side. In the present embodiment, however, there is disclosed an example of the occasion wherein a hologram structure representing a diffraction grating composed of an irregularity portion of a binary pattern is formed on a curved surface portion on one side and a blaze-shaped diffraction grating structure is formed on a curved surface portion on the other side.

To be concrete, a circular drawing as an example of a drawing pattern to be drawn is disclosed on curved surface portion 420a on one side of base material 420 as shown in FIG. 22, and in the drawing where E portion representing a part of a drawing portion on an pattern-drawn field is enlarged, hologram structure 422 composed of plural irregularity is formed on the base material 420. Incidentally, it is preferable that the base material 420 is constituted of an optical element such as, for example, a pickup lens.

The hologram structure 422 transmits light entering the curved surface portion 420a, and has functions to diffract, polarize and separate emerging light into 0-th order light, +first order light and −first order light, and has convex portion 422a and concave portion 422b.

In a more detailed way, as shown in the drawing where F portion shown in FIG. 22 is enlarged, hologram structure 422 has convex portion 422a having the first width dl and concave portion 422b having the second width d2 that is different from the first width d1, and a plurality of them are formed at intervals. Incidentally, by making the structure in the cycle to be asymmetric, light emerging vertically can be polarized and separated.

In the base material 420 of the present embodiment, by constructing the cyclic structure of this kind on curved surface portion 420a, it is possible to separate light transmitted through that structure into 0-th order transmitted light, +first order diffracted light and −first diffracted light.

In this case, as concrete numerical values for d1, d2 and d3 in FIG. 22, it is preferable that d1=200−0.36×200 nm, d2=0.36×200 nm and d3=2320 nm under the assumption that refractive indexₙ of base material 2 is 1.475 and wavelength is 400 nm.

Contents up to this point are the same as those in the first embodiment. In the present embodiment, blaze 426 representing a diffraction grating structure is further constructed on curved surface portion 420b on the other side of base material 420.

To be concrete, in the drawing where a part on the curved surface portion 420b on the other side of the base material 420, a diffraction grating structure composed of a plurality of blazes 426 is formed on the base material 420.

Inclined portion 426b and side wall portion 426a are formed on the blaze 426, and a plurality of the side wall portions 426b are formed along the circumferential direction to be plane-shaped.

In a more detailed way, the surface (the reverse) on the other side of the base material 420 has curved surface portion 420b formed on at least one surface, and a diffraction grating is inclined to be formed for each pitch L1 on the curved surface on the other side of the base material 420, and in at least one pitch L1 of the diffraction grating, there are formed side wall portion 426a that rises from the curved surface portion at a position of an end of the pitch, inclined portion 426b formed between adjacent side wall portions 426a and 426a and groove portion 426c that is formed on a boundary area between the side wall portion 426a and the inclined portion 426b. It is preferable that the blaze form has a structure wherein it is inclined as its position approaches a circumference of the curved surface portion 420b. Incidentally, it is preferable that this diffraction grating structure is formed by drawing coating agents (resist) coated on the curved surface portion. Incidentally, an antireflection structure that prevents reflection of light entering from the inclined portion 426b may be formed on inclined portion 426b.

As stated above, in the present embodiment, it is possible to apply an optical pickup device on an interchangeability basis between CD and DVD, by forming a hologram structure on the surface on one side of a base material and forming plural blazes representing a diffraction grating structure on the surface on the other side. It is further possible to eliminate a decline of a pickup function caused by an increase of an incident angle resulting from grating density, by the structure wherein an inclination of the blaze becomes more steep as its position approaches a circumference of the curved surface portion.

### Fourth Embodiment

Next, the fourth embodiment of the invention will be explained based on FIGS. 23-25.

In the third embodiment stated above, there has been disclosed an example wherein a hologram structure is provided on the curved surface portion on one side of a base material and a blaze-shaped diffraction grating structure is provided on the other side. In the present embodiment, however, the total process for manufacturing the aforementioned structure, in particular, the process to fabricate a metal mold for manufacturing optical lenses such as optical elements will be explained.

Incidentally, the process to provide a hologram structure on the curved surface portion on one side of a base material will be omitted because it is the same as that in the second embodiment stated above, and a manufacturing process for forming a diffraction grating structure on the curved surface on the other side of the base material will be mainly explained.

First, an aspheric surface of a metal mold (electroless nickel) is processed through mechanical processing (working process). Next, resin molding for base material 430 having the hemispherical surface is conducted by a metal mold as shown in FIG. 23(A) (resin molding process). Further, the base material 430 is washed and dried.

Then, surface treatment is conducted on the resin base material 430 (resin surface treatment process). Specifically, the base material 430 is positioned, and a spinner is rotated while resist L representing a coating agent drops for conducting spin coating, as shown in FIG. 23(B). Further, prebaking is also conducted.

After the spin coating, a thickness of a film of the resist is measured to evaluate the resist film (resist film evaluation process). Then, the base material 430 is positioned as shown in FIG. 23(C), and drawing of the curved surface portion having a diffraction grating structure is conducted by three-dimensional electron beam while the base material 430 is controlled respectively by X, Y and Z axes, as in the first embodiment (drawing process).

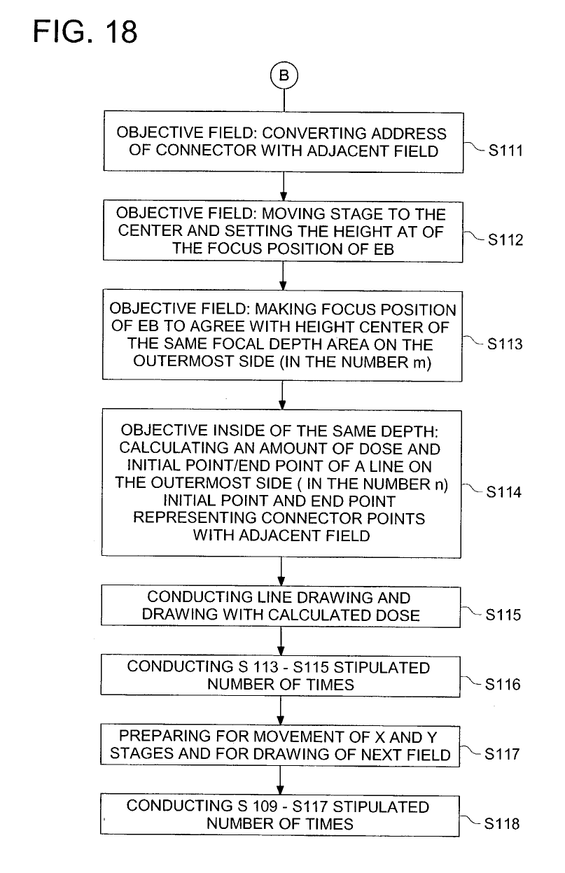

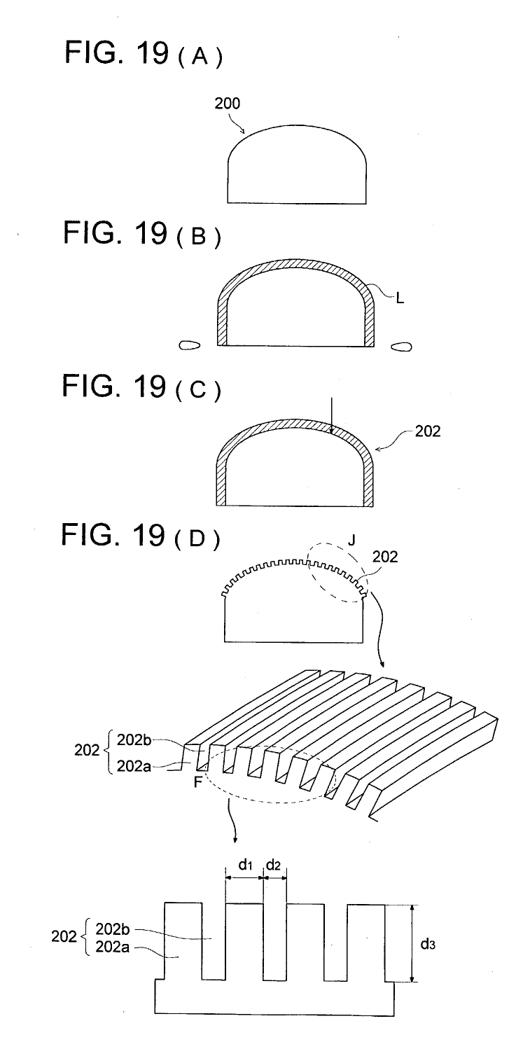

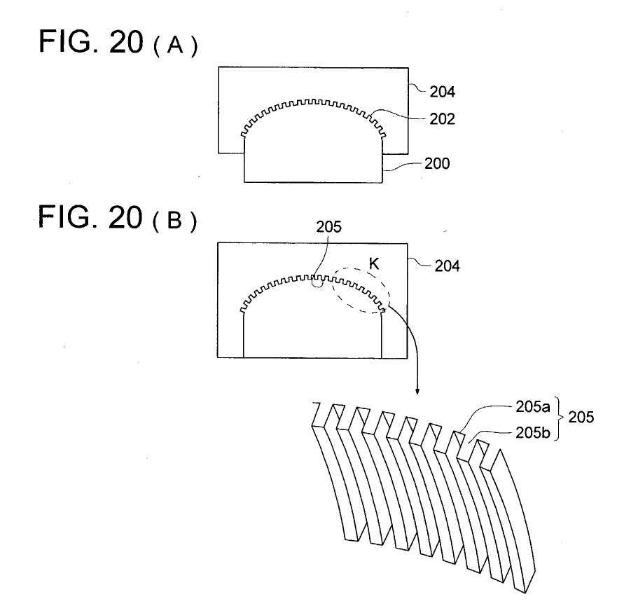

In this case, when forming a blaze representing a diffraction grating structure, it is preferable to conduct S 114 and S 115 in FIG. 18 shown in the first embodiment as follows.

Concretely, measurement of a dose amount, a start point and an end point of a polygon of the outermost (n-th) line is conducted concerning the inside of the same focal depth to be targeted. Incidentally, the start (start point) and the end (end point) are made to be points of linkage with a neighboring field (S 114). In this case, the start point and the end point are made to be an integer, and an amount of dose is expressed by the maximum dose amount determined by the radial position (incident angle) and that multiplied by a coefficient determined by the position of the grating.

Next, drawing is conducted by dose distribution DS (x, y) determined by the dose given in S 114 (S 115). In this case, it is preferable that dose distribution DS is broad for the shallow portion (vertex portion) out of inclined surfaces (inclined portions) and dose distribution DS is sharp for the deep portion (groove portion). Owing to this, it is possible to draft a diffraction grating structure (through a single scanning) by giving the dose distribution. Then, operations from S 113 to S 115 are conducted for the prescribed times (S 116), then, movement of XYZ stage and preparation for drawing a next field are conducted (S 117) and operations from S 109 to S 117 are conducted for the prescribed times (S 118), thus, it is possible to form a base material having a diffraction grating structure on a curved surface portion by an electron beam.

After returning the explanation back to FIG. 23, surface smoothing processing for resist film L on base material 430 is conducted next (surface smoothing process). Further, photographic processing is conducted while the base material 430 is positioned as shown in FIG. 23(D) (development process). Further, surface hardening processing is conducted.

Then, there is conducted a process to evaluate a form of resist through SEM observation and a film thickness measuring apparatus (resist form evaluation process). After that, etching processing is further conducted through dry etching.

In this case, in the drawing where W1 portion of diffraction grating structure 432 is enlarged, the diffraction grating structure is formed by plural blazes each being composed of inclined portion 432b and side wall portion 432a. It is preferable that the blaze is formed so that an angle of the diffraction grating surface becomes steep as its position approaches the peripheral portion.

Next, to make metal mold 434 for surface-treated base material 430, electroforming processing is conducted after conducting metal mold preliminary electroforming processing as shown in FIG. 24(A), and processing to separate the base material 430 from the metal mold 434 is conducted as shown in FIG. 24(B).

Surface treatment is conducted on the metal mold 434 separated from the base material which has been subjected to surface treatment (metal mold surface treatment). Then, the metal mold 434 is evaluated.

In this case, on the metal mold 434, there are formed concave portions 436 so that they correspond to the blazes of the base material 430 in the drawing where W2 portion is enlarged, and on each of the concave portions 436, there are formed side wall portion 436a and inclined portion 436b so that they correspond respectively to hole shapes (inclined portion and side wall portion) of the blaze of the diffraction grating structure 432 of the base material 430.

In this case, when a hologram structure is provided on the curved surface portion on one side of the base material and a blaze-shaped diffraction grating structure is provided on the curved surface portion on the other side of the base material, the metal mold 434 and metal mold 204 of the second embodiment are arranged to face each other after the aforesaid evaluation to fabricate moldings through injection molding. After that the moldings are evaluated.

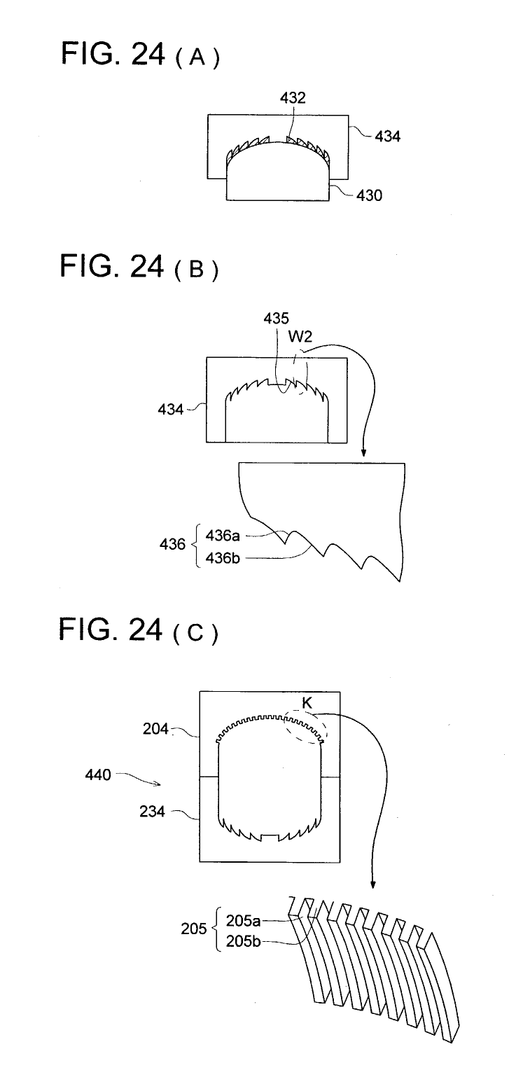

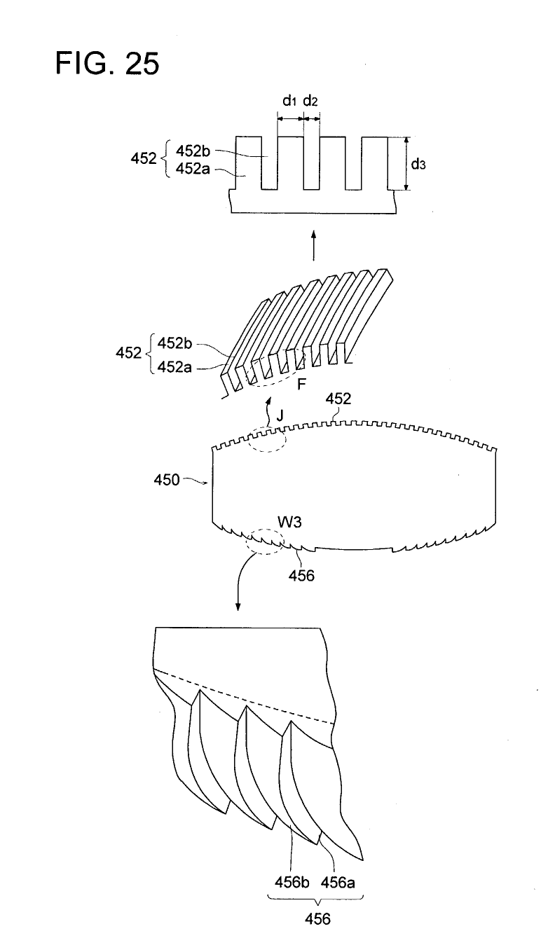

In this case, the structure identical to that in the base material in the third embodiment is completed on injection molding 450, as shown in FIG. 25. To be concrete, as shown in FIG. 25, hologram 452 is formed on the curved surface portion on one side of the base material 450 and blaze-shaped refraction grating structure 456 is formed on the curved surface portion on the other side of the base material 450. In the drawing where J portion is enlarged, concave portion 452b and convex portion 452a both constituting the hologram structure 452 are respectively structured.

Further, in the drawing where F portion is enlarged, the convex portion 452a of the hologram structure 452 has both convex portion 452a having the first width d1 and concave portion 452b having the second width d2 that is different from the first width dl, and a plurality of them are formed at intervals.

On the curved surface portion on the other side, there is formed blaze 456 representing a diffraction grating structure, and in the drawing where W portion is enlarged, there is structured blaze 456 that is composed of side wall portion 456a and inclined portion 456b.

In the present embodiment, by drawing a hologram structure on a curved surface portion of the first base material by using a three-dimensional pattern-drawing apparatus and thereby making the second metal mold based on the second base material, and by drawing a diffraction grating structure on a curved surface portion of the second base material by using a three-dimensional pattern-drawing apparatus and thereby making the second metal mold based on the second base material, to conduct injection molding by arranging the first and second metal molds to face each other, it is possible to make one base material in which a hologram structure is formed on the curved surface on one side of the base material and a blaze shape representing a diffraction grating is formed on the curved surface on the other side of the base material, as stated above.

Incidentally, though the diffraction grating structure is formed on the curved surface portion in the aforementioned embodiment, an occasion wherein the diffraction grating structure is formed on a plane portion is also workable. In addition, an occasion wherein the hologram structure is formed on a plane portion is also workable.

In this way, it is possible to achieve cost reduction in manufacturing, because an optical element can be manufactured by injection molding employing a metal mold. Further, by adding the structure having a hologram structure or the structure having a diffraction grating structure to a metal mold, it is possible to add the function thereof simultaneously when a lens is molded through injection molding, and no additional process is required. Accordingly, it is possible to achieve sharp reduction of cost and reduction of man-hours, compared with an occasion wherein each lens is subjected to an evaporation process as in the past, although there are cost increase of a metal mold itself and an increase in the number of shots (approximately, a million times).

It is further possible to fabricate a hologram structure and a diffraction grating structure simultaneously in a course of injection molding of a plastic lens, which leads to low cost of optical parts.

### Fifth Embodiment

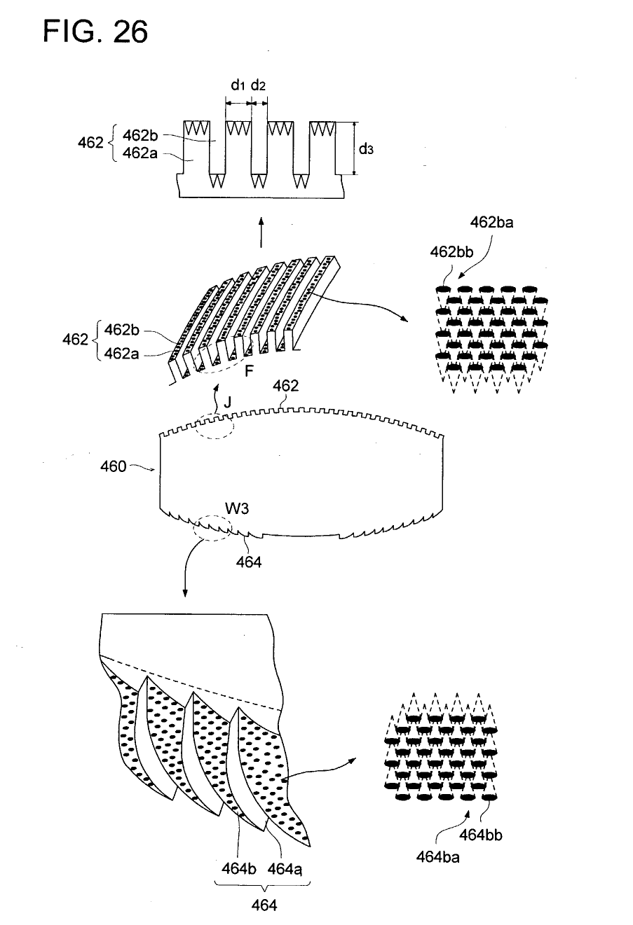

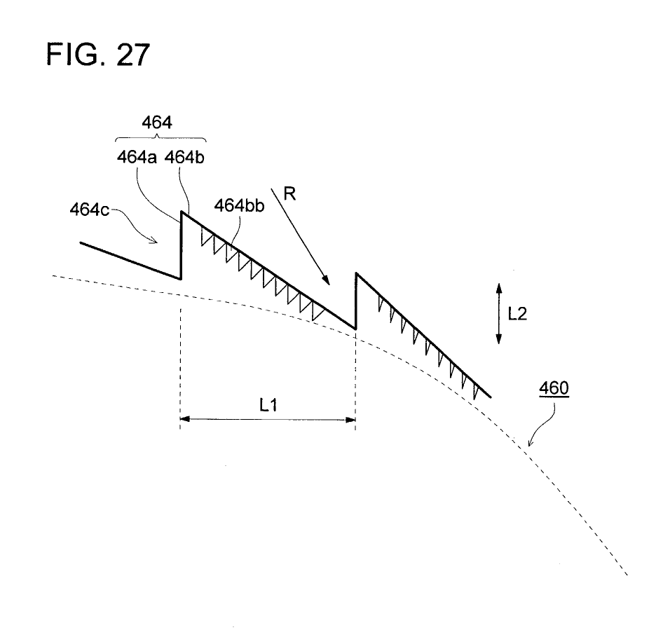

Next, the fifth embodiment of the invention will be explained based on FIGS. 26-27. FIG. 27 is a diagram showing the fifth embodiment of the invention.

In the present embodiment, there is disclosed an occasion wherein an antireflection structure is formed on the surface on one side of the base material (or the optical element representing a molding that is resin-molded by injection molding) disclosed in the first or the third embodiment, or on the surface on the other side or on the both surfaces of the surface on one side and the surface on the other side thereof. Namely, there is illustrated an occasion wherein an antireflection structure is formed on a hologram structure on the curved surface portion on one side, and an antireflection structure is formed on a blaze-shaped diffraction grating on the other side.

(Explanation of Construction)

Specifically, as shown in FIG. 26, hologram structure 462 composed of plural irregularity is formed on the curved surface on one side of the base material 460, in the drawing where J portion is enlarged. Incidentally, it is preferable that the base material 460 is constituted of an optical element such as, for example, a pickup lens.

The hologram structure 462 transmits light entering the curved surface portion 460a, and has functions to diffract, polarize and separate emerging light into 0-th order light, +first order light and −first order light, and has convex portion 462a and concave portion 462b.

In a more detailed way, as shown in the drawing where F portion shown in FIG. 26 is enlarged, hologram structure 462 has convex portion 462a having the first width d1 and concave portion 462b having the second width d2 that is different from the first width d1, and a plurality of them are formed at intervals. Incidentally, by making the structure in the cycle to be asymmetric, light emerging vertically can be polarized and separated.

In the base material 460 of the present embodiment, by constructing the cyclic structure of this kind on curved surface portion 460a, it is possible to separate light transmitted through that structure into 0-th order transmitted light, +first order diffracted light and −first diffracted light.

In this case, as concrete numerical values for d1, d2 and d3 in FIG. 26, it is preferable that d1=200−0.36×200 nm, d2=0.36×200 nm and d3=2320 nm under the assumption that refractive indexₙ of base material 2 is 1.475 and wavelength is 400 nm.

In addition, on each of a vertex portion of convex portion 462a and a bottom wall portion of concave portion 462b, there is formed antireflection structure 462ba that prevents reflection of light entering through curved surface portion 460a. It is preferable that the antireflection structure 462ba is of the form composed of plural irregularity which are double-refracted constructively, and it is formed by plural hole portions 462bb in the present embodiment. This hole portion 462bb is in a shape that tapers off as its position moves in the direction toward its depth, an aperture diameter of the hole portion 462bb is formed in a unit of submicron, and a ratio of an area of the hole portion 462bb to that of the curved surface portion 460a is about 30%.

Though there has been explained an example to provide plural holes as an antireflection structure in the present embodiment, the invention is not limited to the form of this kind, and when the antireflection structure is formed by plural convex forms, an example wherein the hole portions and convex portions are combined is also workable.

On the other hand, on the curved surface portion side on the other side of base material 460, there are formed diffraction grating structure 464 composed of plural blazes.

A blaze of the diffraction grating structure 464 forms inclined portion 464b and side wall portion 464a, and a plurality of the side wall portions 464b are formed in a plane shape along the circumferential direction.

In a more detailed way, as shown in FIG. 27, a diffraction grating is inclined to be formed for each pitch L1 on the curved surface on the other side of the base material 460, and in at least one pitch L1 of the diffraction grating, there are formed side wall portion 464a that rises from the curved surface portion at a position of an end of the pitch, inclined portion 464b formed between adjacent side wall portions 464a and 464a and groove portion 464c that is formed on a boundary area between the side wall portion 464a and the inclined portion 464b. Incidentally, it is preferable that this diffraction grating structure is formed by drawing coating agents (resist) coated on the curved surface portion.

After returning the explanation back to FIG. 26, antireflection structure 464ba that prevents reflection of light entering through the inclined portion 464b is formed on inclined portion 464b. It is preferable that the antireflection structure 464ba is of the form composed of plural irregularity which are double-refracted constructively, and it is formed by plural hole portions 464bb in the present embodiment. This hole portion 464bb is in a shape that tapers off as its position moves in the direction toward its depth, an aperture diameter of the hole portion 464bb is formed in a unit of submicron, and a ratio of an area of the hole portion 464bb to that of the inclined portion 464b is about 30%.

Though there will be explained an example to provide plural holes as an antireflection structure in the present embodiment, the invention is not limited to the form of this kind, and when the antireflection structure is formed by plural convex forms, an example wherein the hole portions and convex portions are combined is also workable.

Now, although a cyclic grating having a sub-wavelength structure has a great influence on characteristics of light wave for transmission and reflection, antireflection effects can be taken out by microscopic irregularity. Namely, there will be resulted a structure wherein the refractive index is changed continuously and light is hardly reflected because the average refractive index is changed gradually in the direction toward a thickness of base material 2 by the taper, though reflection of light is caused by a sudden change of refractive index.

Due to this, it is possible to prevent reflection by making the antireflection structures 464ba and 462ba to have continuous distribution of refractive index with collective actions of light in a sub-wavelength order, although the high density diffraction grating structure causes surface reaction as it is.

By drawing a cluster structure of sub-wavelength order in synchronization with drawing of diffraction grating with three-dimensional drawing, and by forming, on the base material 2, a structure to prevent surface reflection as stated above, it is possible to reduce cost sharply when forming a metal-mold-shaped antireflection structure.

Further, even when a curvature of the curved surface portion is made to be great by high density, it is possible to reduce reflection on the surface of the peripheral portion and to reduce a difference in transmittance caused by a difference of a direction of deflection. Due to this, a pickup function is not lowered in a process of reading detection signals.

Further, even for those provided with a diffraction grating for interchangeability between DVD and CD and for correction of aberration, it is possible to eliminate a decline of a pickup function caused by an incident angle increased by grating density.

(Process of Processing)

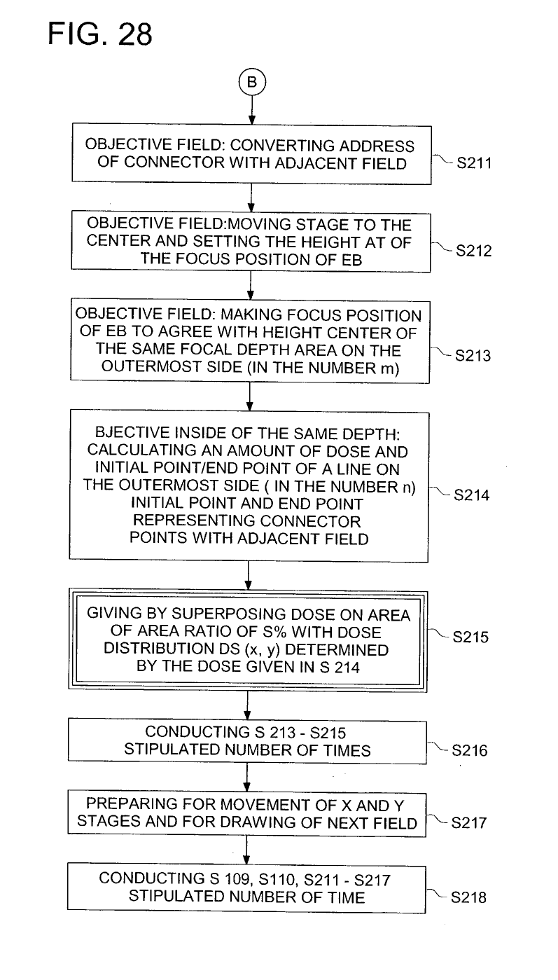

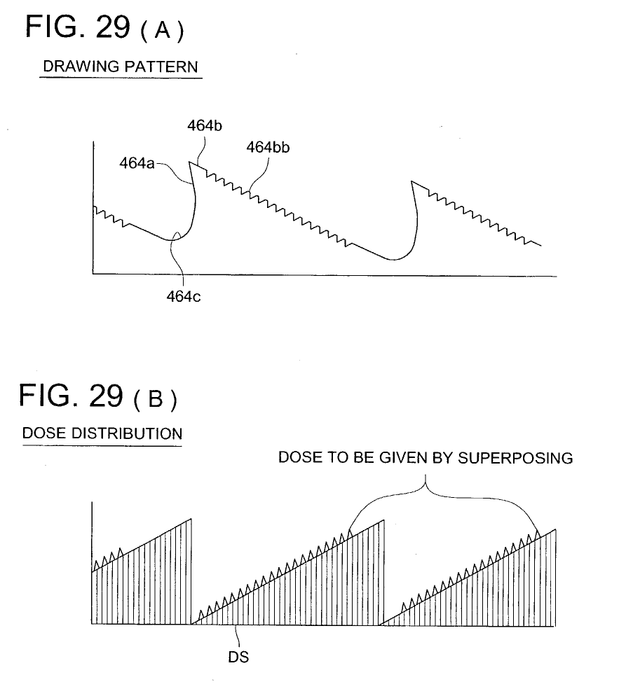

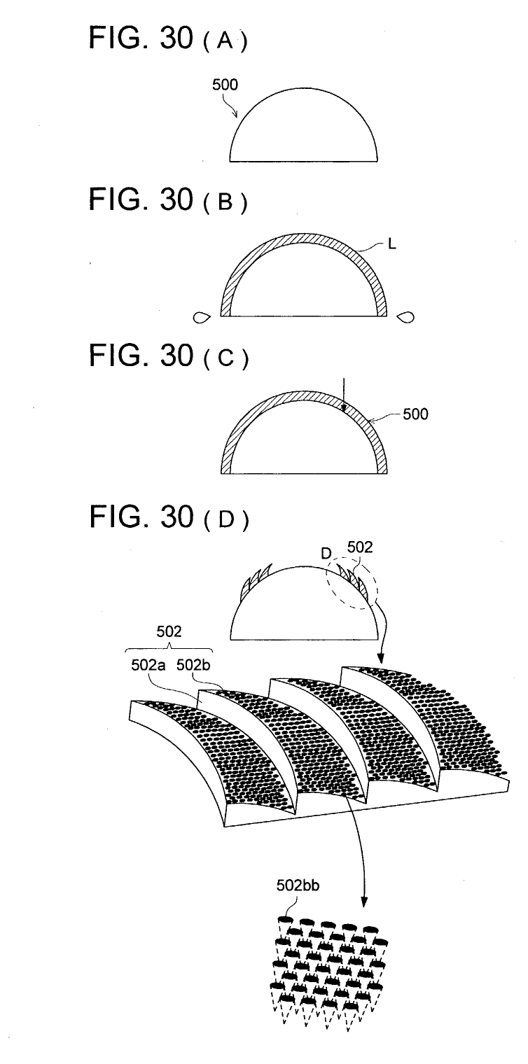

Next, there will be explained, by referring to FIGS. 28 and 29, the processing procedures for drawing an antireflection structure on a hologram structure on the curved surface portion by an electron beam in the base material having the structure mentioned above.

Incidentally, basic drawing procedures in the case of forming a hologram structure on the curved surface portion of the base material and in the case of forming a double refraction phase structure on the curved surface portion of the base material are the same as those in the first embodiment. Therefore, points of forming an antireflection structure will mainly be explained here.

Namely, operations from S 101 in FIG. 16 to S 113 in FIG. 18 in the first embodiment are the same as those in the present embodiment, and it is preferable that S 114 and S 115 shown in the first embodiment are conducted as follows.

Namely, measurement of a dose amount, a start point and an end point of a polygon of the outermost (n-th) line is conducted concerning the inside of the same focal depth to be targeted. Incidentally, the start (start point) and the end (end point) are made to be points of linkage with a neighboring field (S 214). In this case, the start point and the end point are made to be an integer, and an amount of dose is expressed by the maximum dose amount determined by the radial position (incident angle) and that multiplied by a coefficient determined by the position of the grating.

Next, the dose is superposed on the area having a ratio of an area of S % to be given (S 215) by dose distribution DS (x, y) determined by the dose given in S 214. In this case, a spread of the additional dose including nearness effect is made to be covered by a slope (inclined portion) of the blaze. Further, it is preferable to create dose distribution shown in FIG. 29(B) by making dose distribution DS to be broad for the shallow portion (vertex portion) out of slopes (inclined portions) and making dose distribution DS to be sharp for the deep portion (groove portion).

Owing to this, by giving the aforementioned dose distribution, it is possible to conduct drawing of a diffraction grating structure and drawing of an antireflection structure simultaneously (by scanning one time). Then, operations from S 213 to S 215 are performed for prescribed times (S 216).

Next, movement of XYZ stage and preparation for conducting drawing of next field are performed (S 217). In this case, field numbers, time and temperatures are registered in data base (DB).

By performing the aforementioned S 109, S 110 (FIG. 18), S 211 and S 217 in the way stated above (S218), it is possible to form an antireflection structure (cluster) on the base material having a diffraction grating structure on its curved surface portion, by an electron beam.

In the present embodiment, it is possible to prevent, by collective actions of light of sub-wavelength order, a reflection by forming a hole section for the continuous distribution of refractive index on the base material having a hologram structure or a diffraction grating structure on its curved surface portion as the antireflection structure, although a high density diffraction grating structure causes great surface reflection as it is.

Further, even when a curvature of the curved surface portion is made to be great by high density, it is possible to reduce reflection on the surface and to reduce a difference in transmittance caused by a difference of a direction of deflection. Due to this, a pickup function is not lowered in a process of reading detection signals.

Further, even for those provided with a diffraction grating for interchangeability between DVD and CD and for correction of aberration, it is possible to eliminate a decline of a pickup function caused by an incident angle increased by grating density.

Incidentally, as the antireflection structure, there are considered various types of structures, and when plural hole portions each having a taper that tapers off as its position moves in the direction toward its depth are formed, and when a ratio of an area is made to be 30% of the inclined portion, reduction of the surface reflection rate becomes remarkable.

### Sixth Embodiment

Next, the sixth embodiment of the invention will be explained based on FIGS. 30-31.

In the aforementioned fifth embodiment, there has been disclosed a process to conduct precision processing on the base material by an electron beam, for a hologram structure and a diffraction grating structure including an antireflection structure. In the present embodiment, however, there will be explained a process for the total processing including the aforesaid processes, in particular, a process to manufacture a metal mold for manufacturing an optical lens such as an optical element through injection molding.

First, an aspheric surface of a metal mold (electroless nickel) is processed through mechanical processing (working process). Next, resin molding for base material 500 having the hemispherical surface is conducted by a metal mold as shown in FIG. 30(A) (resin molding process). Further, the base material 500 is washed and dried.

Then, surface treatment is conducted on the resin base material 500 (resin surface treatment process). Specifically, the base material 500 is positioned, and a spinner is rotated while resist L drops for conducting spin coating, as shown in FIG. 30(B). Further, prebaking is also conducted.

After the spin coating, a thickness of a film of the resist is measured to evaluate the resist film (resist film evaluation process). Then, the base material 500 is positioned as shown in FIG. 30(C), and drawing on the curved surface portion having blaze-shaped diffraction grating structure including an antireflection structure 502 is conducted by three-dimensional electron beam while the base material 500 is controlled respectively by X, Y and Z axes, as in the fifth embodiment (drawing process).

Next, surface smoothing treatment is conducted on resist film L on the base material 500 (surface smoothing process). Further, photographic processing is conducted while the base material 500 is positioned as shown in FIG. 30(D) (development process). Further, surface hardening processing is conducted.

Then, there is conducted a process to evaluate a form of resist through SEM observation and a film thickness measuring apparatus (resist form evaluation process).

After that, etching processing is further conducted through dry etching. In this case, in the drawing where D portion of diffraction grating structure 502 is enlarged, the diffraction grating structure is formed by plural blazes composed of inclined portion 502b and side wall portion 502a, and an antireflection structure composed of plural hole portions 502bb each having a taper that tapers off as its position moves in the direction toward its depth is formed on the inclined portion 502b. These plural hole portions 502bb form an area that is about 30% (more preferable is a range of about 20%-40%) of an area of the inclined portion 502b. Since an angle of a diffraction grating surface of this blaze becomes steep as its position approaches the peripheral portion, it is preferable that an angle of a taper of a hole portion is formed by an angle that changes in accordance with a change of an angle of a diffraction grating surface.

Next, for fabricating metal mold 504 for base material 500 which has been subjected to surface treatment, electroforming processing is conducted after conducting metal mold preliminary electroforming as shown in FIG. 31(A), and processing to separate the base material 500 from the metal mold 504 is conducted as shown in FIG. 31(B).

Surface treatment is conducted on the metal mold 504 separated from the base material which has been subjected to surface treatment (metal mold surface treatment process). Then, the metal mold 504 is evaluated.

In this case, in the drawing where W4 portion is enlarged, concave portions 505 are formed on the metal mold 504 to correspond to the blazes of the base material 400, and plural convex portions 506 are formed on the concave portions 505 to correspond to hole portions of inclined portion 502b of the base material 400.

After the evaluation is conducted in the aforesaid way, the metal mold 504 is used to manufacture moldings through injection molding as shown in FIG. 31. After that, the moldings are evaluated.

In this case, as shown in FIG. 31(C), on injection-molded molding 510, there is completed a structure identical to that in the fifth embodiment, and diffraction grating structure 511 composed of plural blazes is formed on the curved surface. In the drawing where W5 portion is enlarged, one pitch of the diffraction grating constitutes a blaze that is composed of side wall portion 512b and inclined portion 512a, and on this inclined portion 512a, there is provided an antireflection structure composed of plural hole portions 513 each having a diameter in a unit of submicron.

In the present embodiment, when forming an optical element (for example, a lens) as a base material of the fifth embodiment, a cluster structure in sub-wavelength order is drafted in synchronization with drawing of a diffraction grating on a three-dimensional pattern-drawing apparatus, so that the antireflection structure may be formed as a form of a metal mold, and thereby, the optical element can be manufactured through injection molding by the use of a metal mold, which makes it possible to achieve reduction of manufacturing cost.

Further, by adding a structure having an antireflection function as a metal mold, it is possible to add functions simultaneously when molding a lens through injection molding, and no addition of process is required. Therefore, it is possible to achieve sharp reduction of cost and reduction of man-hours, compared with an occasion wherein each lens is subjected to vacuum evaporation processing in succession as in the past, although there are cost increase of a metal mold itself and an increase in the number of shots (approximately, a million times).

Since it is further possible to fabricate a microscopic structure for antireflection simultaneously in the course of injection molding of a plastic lens, no process of vacuum evaporation is required, which leads to low cost of optical parts.

In particular, it is also possible to apply to the lens which has no diffraction grating structure and is made through injection molding, and a step of vacuum evaporation cab be eliminated, which makes it possible to realize sharp reduction of cost.

### Seventh Embodiment

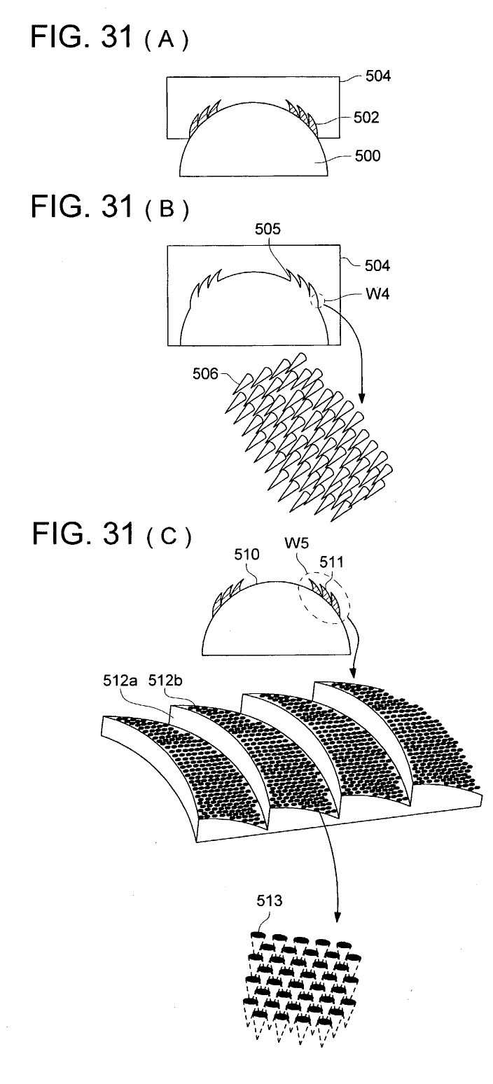

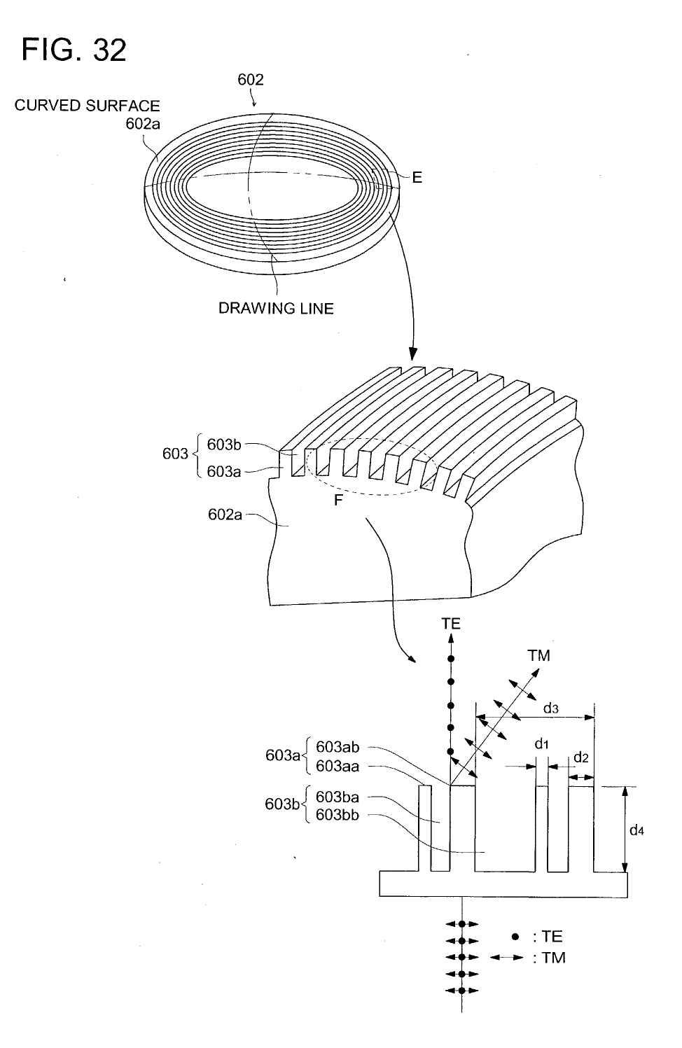

Next, the seventh embodiment of the invention will be explained based on FIG. 32. In the embodiment stated above, there has been illustrated an occasion for forming a blaze-shaped diffraction grating structure when a wavelength plate function representing a double refraction phase structure composed of irregularity is formed on a plane portion or a curved surface portion on the other side, under the assumption that a hologram structure is formed on a curved surface portion on one side. However, a polarized light separating structure may also be formed on a surface on the other side.

To be concrete, as shown in FIG. 32, there is disclosed a circle drawing on the curved surface portion on one side as an example of a drawing pattern to be drawn on base material 602 having a hologram structure, and in the drawing where E portion representing a part of a drawing portion having, on its pattern-drawn field, a curved surface portion 602a is enlarged, polarized light separating structure 603 composed of plural irregularity is formed on the base material 602.

The polarized light separating structure 603 has a function to polarize and separate light that enters or emerges from the curved surface portion 602a into two polarization components representing TE wave and TM wave oscillating in at least two directions each being perpendicular to the other in a plane that crosses an advancing direction of the light, and is provided with convex portion 603a and concave portion 603b.

In a more detailed way, as shown in the drawing where F portion is enlarged as shown in FIG. 32, the convex portion 603a of the polarized light separating structure 603 has therein the first convex portion 603aa having the first width dl and the second convex portion 603ab having the second width d2 which is different from the first width d1, and a plurality of them are formed at intervals. Between the first convex portion 603aa and the second convex portion 603ab, there are formed the first concave portion 603ba that is narrow in width and the second concave portion 603bb that is wide in width, and these first and second concave portions 603ba and 603bb constitute concave portion 603b. Incidentally, these first and second convex portions 603aa and 603ab are formed to have a height of d4, and the first convex portion 603aa, the second convex portion 603ab, the first concave portion 603ba and the second concave portion 603bb form one unit whose length is d3, and a plurality of the units constitute a cyclic structure. Incidentally, it is possible to polarize and separate even for light that enters perpendicularly, by making the structure in the cycle to be asymmetric.

On the base material 602 of the present embodiment, by providing the cyclic structure of this kind on curved surface portion 62a, it is possible to separate light that is transmitted through the aforesaid structure into TE wave (wave having only electric field component without having magnetic field component on the plane perpendicular to the advancing direction) and TM wave (wave having only magnetic field component without having electric field component on the plane perpendicular to the advancing direction).

In this case, as concrete numerical values of d1, d2, d3 and d4 in FIG. 32, it is preferable that d1 is 0.25λ, d2 is 0.39λ, d3 is 2λ and d4 is 1.22λ, for example, under the assumption that refractive index n of base material 602 is 1.92 and a wavelength is λ.

As stated above, by providing polarized light separating structure 603 composed of irregularity in a shape shown in FIG. 32 on curved surface portion 602a, it is possible to polarize and separate light into TE wave and TM wave. Incidentally, in a strict sense, a distributive ratio of transmittance for each of TE wave and TM wave is, for example, 0.575 for TE wave and 0.036 for TM wave in the case of +first order, 0.031 for TE wave and 0.574 for TM wave in the case of 0-th order, and 0.036 for TE wave and 0.016 for TM wave in the case of −first order, but, −first order is negligible small and it is not a problem.

As stated above, it is possible to form an optical lens equipped with a polarized light separating structure on an entire surface finally, by drawing a cyclic structure by irregularity in a sub-wavelength order and by forming a polarized light separating structure on the base material, synchronizing with an occasion for drawing a curved surface portion by drawing on a three-dimensional basis. Therefore, it may be possible to apply this to various equipment, in place of conventional polarized light separating element.

The reason for the foregoing is that the element having the polarized light separating structure can be manufactured successively on a mass production basis as a final molding made through injection molding, by fabricating a metal mold based on the aforesaid base material. It is therefore possible to achieve sharp reduction of manufacturing cost and improvement of productivity, when labor and time in each process for forming a polarized light separating element one by one in the past are taken into consideration.

### Eighth Embodiment

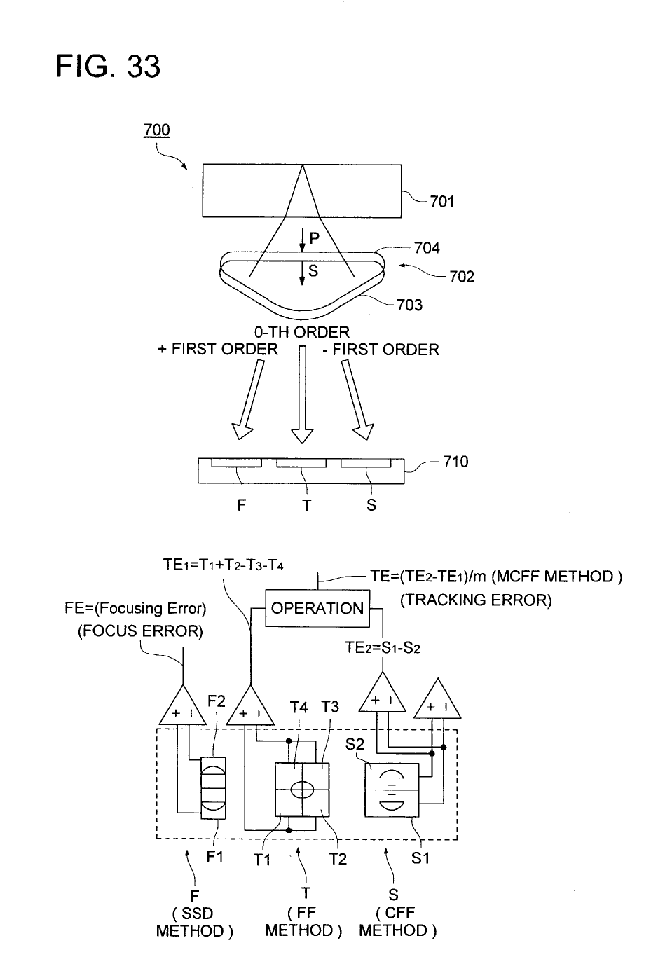

Next, the eighth embodiment of the invention will be explained based on FIG. 33 which is a functional block diagram showing the eighth embodiment of the invention.

In the present embodiment, there is disclosed an example of an optical pickup device representing an example of an electronic equipment employing a base material to be drawn (base material) which has been drafted by the aforesaid electron beam pattern-drawing apparatus (or an optical element representing a molding molded with resin through injection molding).

In FIG. 33, optical pickup device 700 has therein an unillustrated semiconductor laser, magneto-optical disk 701 such as DVD and CD (magneto-optical recording medium), objective lens 702 which is of resin and is equipped with hologram structure 703 on the surface on one side and with wavelength plate structure 704 representing a double refraction phase structure on the surface on the other side, and has a structure identical to that in the first embodiment, and multi-pattern light detector 710.

Incidentally, wavelength plate structure 704 of the objective lens 702 is provided with a function equal, for example, to that of ¼ wavelength plate.

In optical pickup device 700 having the structure mentioned above, a laser beam emitted from an unillustrated semiconductor laser is converged by objective lens 702 to the diffraction limit, then, is applied on magneto-optical disk 701 (magneto-optical recording medium) to pick up recording signals to be reflected. The reflected laser beam coming from the magneto-optical disk 701 enters the objective lens 702 to become a collimated light, then, is transmitted through wavelength plate structure 704 to be changed in terms of a polarized light direction, and enters hologram structure 703 which transmits an ordinary light as 0-th order diffracted light, and a polarized light of the incident light that is transmitted through the wavelength plate structure 704 is diffracted as the +first order diffracted light and the −first order diffracted light, thus, the polarized light is separated into three light-fluxes of 0-th order, the +first order and −first order, and enters multi-pattern light detector 710.

On a separation light-receiving area (light-receiving element) of the multi-pattern light detector 710, there are formed respective spots F, T and S to arrange so that the +first order diffracted light may detect focus errors (Focusing: FE <Focusing Error>) and tracking errors may be detected when 0-th order transmitted light is inputted in T area and the −first order diffracted light is inputted in S area.

Incidentally, in respective three detecting systems, focus error signals of FE=F1−F2 representing differential signals of F1 and F2 are calculated through SSD method based on the +first order diffracted light in F area (focus error detecting section), and based on this, the focus error is calculated.

Further, in T area (first tracking error detecting section), the first tracking error signal representing TE1=T1+T2−(T3+T4) is calculated through FF method, based on 0-th order transmitted light.

On the other hand, in S area (second tracking error detecting section), the second tracking error signal representing TE2=S1−S2 is calculated through CFF method, based on −first order transmitted light.

Then, based on the first tracking error signal TE1 and the second tracking error signal TE2, there is calculated the tracking error signal representing TE=(TE1−TE2)/m through MCFF (Modified Correct FarField Detection) method in the operation section, and based on this, the tracking error is calculated.

As stated above, 0-th order, −first order and +first order diffracted light are used for error detecting signals for respective focus error and tracking error.

As stated above, in the present embodiment, by using an optical lens which is equipped with a hologram structure on the surface on one side and with a wavelength plate structure on the surface on the other side (molded solidly), it is possible to achieve sharp cost reduction by reducing the number of parts and by reducing the number of parts to be attached, without requiring an exclusive hologram plate and an exclusive wavelength plate which were used in the past.

Further, since arrangement of a hologram plate and a wavelength plate is unnecessary, a space to be occupied by arrangement of members can be reduced, downsizing of an optical pickup device can be achieved and adjustment of an optical system in the pickup device becomes unnecessary.

In addition, in the optical pickup device, downsizing and unification are easy, and tracking mechanism can be simplified.

Incidentally, though an occasion wherein a wavelength plate structure is provided on the surface on the other side of the objective lens was exemplified in the embodiment stated above, it is also possible to employ the structure wherein no wavelength plate is used.

Though 0-th order light and −first order light were used for tracking and +first order light was used for focusing in the structure mentioned above, an assignment of 0-th order light, −first order light and +first order light to functions is optional.

Further, the structure of an optical detector by various other methods for detecting car signal reading, focus errors and tracking errors without being limited to the focus errors and tracking errors is also workable.

### Ninth Embodiment

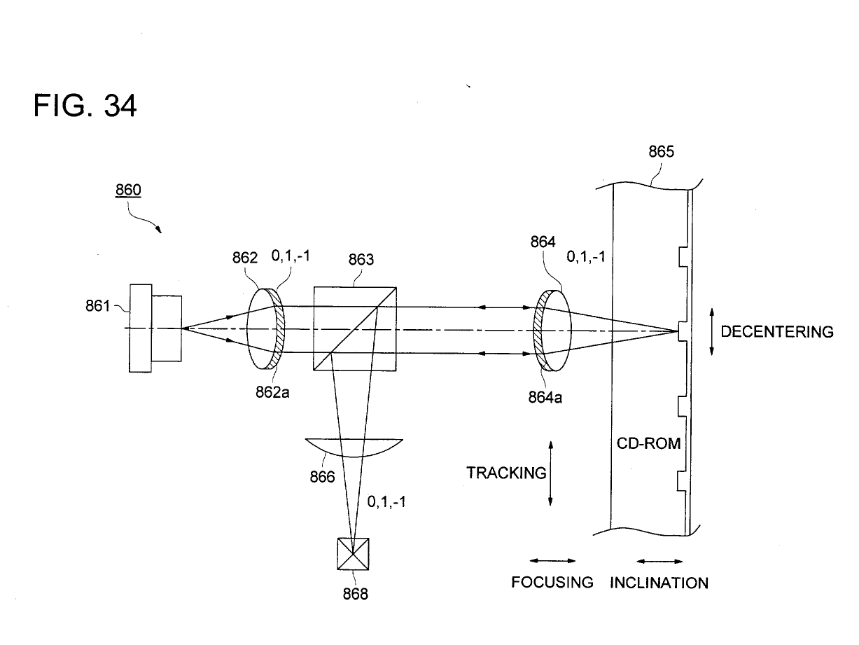

Next, ninth embodiment of the invention will be explained as follows, referring to FIG. 34. FIG. 34 is a functional block diagram showing ninth embodiment of the invention.

In the present embodiment, there is disclosed an example of an optical pickup device representing an example of an electronic equipment employing a base material (or an optical element representing a molding that is resin-molded through injection molding) representing the aforesaid embodiment or its variation.

In FIG. 34, optical pickup device 860 has therein semiconductor laser 861, collimator lens 862 (first optical element), separation prism 863, objective lens 864 (second optical element), magneto-optical disk 865 such as DVD and CD (magneto-optical recording medium), light-converging lens 866 and multi-pattern light detector 868.

Among the foregoing, in the present embodiment, an optical element including a hologram structure in the previous embodiment is applied to collimator lens 862 independently of existence of a curved surface portion, for example, and an optical element including a double refraction phase structure (function of wavelength plate) on one surface in the previous embodiment is applied, for example, to objective lens 864.

In the optical pickup device 860 having the aforesaid structure, a laser beam emitted from semiconductor laser 861 is made to be collimated light by collimator lens 862. In this case, the collimated light is divided into 0-th order diffracted light, +first order diffracted light and −first order diffracted light by hologram structure 862a. The collimated light including these diffracted light is transmitted through separation prism 863, and is converged by objective lens 864 to the diffraction limit to be applied on magneto-optical disk 865 (magneto-optical recording medium).

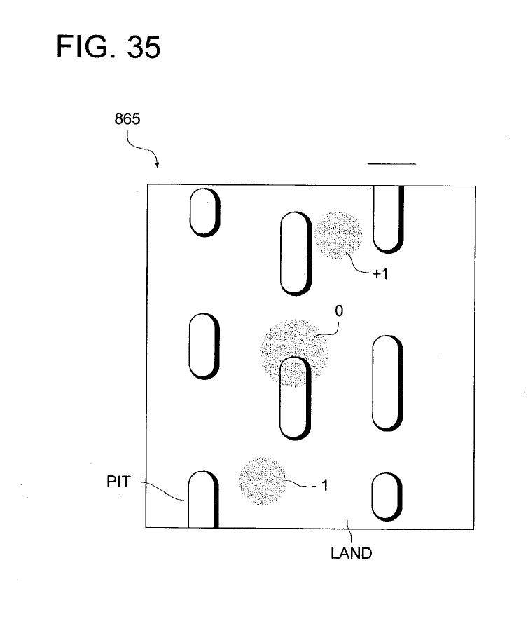

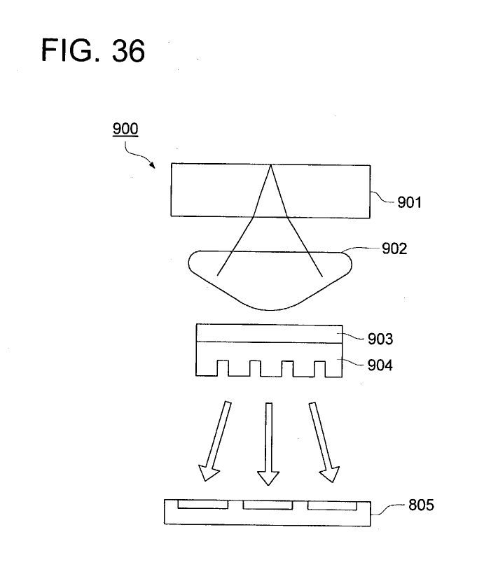

In this case, 0-th order light, +first order light and −first order light shown in FIG. 35 are applied on magneto-optical disk 865.

The 0-th order laser reflected light, +first order laser reflected light and −first order laser reflected light from the magneto-optical disk 865 enter objective lens 864 to become collimated light again. In this case, the polarization direction of the collimated light is rotated by a prescribed angle by wavelength plate structure 864a, then, the collimated light is reflected by separation prism 863, and is converged by light-converging lens 866. Thus, 0-th order diffracted light, +first order diffracted light and first order diffracted light form their spots on a separation light-receiving area (light-receiving element) of multi-pattern light detector 868.

Thus, the structure stated above can be used for the optical system for generating each light that is used for each control of focusing or tracking.

Incidentally, by providing also a diffraction grating structure on objective lens 864, it is possible to conduct aberration correction for interchangeable CD and DVD. In this case, it is possible to eliminate a decline of a pickup function caused by an increase of an incident angle resulting from grating density, by the structure wherein an inclination of the blaze representing the diffraction grating structure becomes more steep as its position approaches a circumference of the curved surface portion.

As stated above, in the present embodiment, by using an optical lens which is equipped with a hologram structure on the surface on one side and with a wavelength plate structure on the surface on the other side (molded solidly), it is possible to achieve sharp cost reduction by reducing the number of parts and by reducing the number of parts to be attached, without requiring an exclusive hologram plate and an exclusive wavelength plate which were used in the past.

Further, since arrangement of a hologram plate and a wavelength plate is unnecessary, a space to be occupied by arrangement of members can be reduced, downsizing of an optical pickup device can be achieved and adjustment of an optical system in the pickup device becomes unnecessary.

In addition, in the optical pickup device, downsizing and unification are easy, and tracking mechanism can be simplified.

Incidentally, an apparatus and a method of the invention have been explained up to this point based on some specific embodiments. It is possible for persons skilled in the art to modify variously the embodiments described in the text of the invention without departing from the spirit and scope of the invention.

For example, although there has been explained an occasion wherein a hologram structure or a double refraction phase structure is formed on a curved surface portion of the base material having the curved surface portion on one surface, in each embodiment described above, it is naturally possible to employ an occasion to form on a base material whose one surface is a plane. Further, an occasion to form a diffraction grating on a plane portion without being limited to the foregoing is also workable.

Further, in the embodiments described above, there has been explained an occasion wherein drawing is conducted directly on a base material of an optical element such as an optical lens. However, it is also possible to use the aforesaid principles and processing procedures as well as processing methods when processing a molding die (metal mold) that forms an optical lens made of resin through injection molding.

AS a base material, there has been disclosed an example of a pickup lens used for DVD and CD, and this pickup lens can also be applied to an objective lens having no diffraction grating on a surface on one side, a DVD-CD interchangeable lens having a diffraction grating pitch of 20μ and a high density blue laser interchangeable objective lens having a diffraction grating pitch of 3μ.

Further, when using an optical element as a base material, an electronic equipment having that base material may also be other various optical equipment or electronic equipment without being limited to the aforesaid reading apparatus such as DVD or CD. Namely, the base material can be applied to various optical equipment or electronic equipment without being limited to an optical pickup apparatus having the aforesaid structure, and the equipment may naturally be those wherein various hologram structures or a wavelength structure and a diffraction grating structure are formed on various lenses, for example, a light-converging lens and a cylindrical lens, without being limited to an objective lens. In this case, the structure of an optical system used for a magneto-optical disk apparatus including an optical pickup device may be of any of a read-only form, a write-once form and a rewriting form. Further, for detecting a focusing error signal, any of an astigmatism method, a Foucault's method (knife edge method), a beam size method and a critical angle method can be used. Even for detection of tracking error signals, any of a three-beam method, a continuous servo method and a sample servo method.

When forming by inclining at least one pitch portion of a diffraction grating for a base material having at least a curved surface portion, the structure having at least a groove portion (or an occasion-where groove portions are formed at microscopic pitches) on the base material is also workable. Further, the occasion where irradiation is conducted under the condition that an electron beam is inclined at a prescribed angle is also workable.

Further, it is possible to employ the structure wherein a step to measure a plurality of standard points on a base material, to calculate a standard coordinates system based on results of the measurement, and to measure distribution of a thickness of the base material based on the coordinates system is carried out in the course of irradiation of an electron beam. It is further possible to employ the structure wherein a calculation step to calculate an optimum focus position based on the distribution of thickness, and a step to adjust to align the focus position with a drawing position are carried out in the course of irradiation of an electron beam.

Although there has been exemplified an occasion wherein the first base material, the second base material, the first metal mold and the second metal mold are used when forming a hologram structure on the surface on one side of the base material, and forming a double refraction phase structure or a diffraction grating structure on the surface on the other side, an occasion wherein drawing is conducted on the surface on one side of the base material having a certain thickness and then, drawing is conducted on the surface on the other side, and a metal mold is fabricated to manufacture for one base material, is also workable.

The embodiment stated above is of the structure wherein when a hologram structure is formed on the curved surface on one side and a blaze-shaped diffraction grating structure is formed on the curved surface on the other side, each of the hologram structure and the diffraction grating structure includes an antireflection structure. However, it is also possible to employ the structure wherein when a hologram structure is formed on the curved surface portion on one side and a wavelength plate structure representing a double refraction phase structure is formed on the curved surface on the other side, either one or both of the hologram structure and the double refraction phase structure include the antireflection structure. In particular, it is preferable that an antireflection structure that prevents reflection of light entering through an inclined portion is formed on the inclined portion in the case of a blaze, and an antireflection structure is formed on each of a convex vertex portion and a concave bottom wall portion in the case of a binary.

Incidentally, though there has been exemplified an occasion wherein a hologram structure is provided on the surface on one side of a base material and a diffraction grating structure is provided on the surface on the other side of the base material, in the embodiment stated above, an occasion wherein a double refraction phase structure is provided on the surface on one side of the base material and a diffraction grating structure is provided on the surface on the other side of the base material is naturally workable.

Further, an arrangement wherein a surface on one side is a curved surface and a surface on the other side is a plane is also workable. Further, though there has been explained an occasion wherein a diffraction grating structure is formed on a curved surface portion of the base material having the curved surface portion on its surface, in each embodiment, an occasion wherein a diffraction grating structure is formed on the base material whose one surface is a plane is also workable.

Though it is preferable that both surfaces are of the binary structure, the surface on the other side may be of a blaze.

In addition, the surface on at least one side is a curved surface which has thereon a microscopic structure of some kind or other, and a hologram structure has only to be provided on either one of the surface and the reverse. In this case, as an optical element, a hologram structure has only to be provided on a surface on one side, and a surface on the other side is free whether it is an ordinary curved surface, a plane surface or a surface having a diffraction grating structure, a polarizing plate function or a wavelength plate function, as an optical element.

It is naturally necessary to change a form of a metal mold in accordance with a shape of the base material or of an optical element.

In addition, the occasion wherein a plurality of electron beams each being capable of conducting multiple drawing independently are structured is workable, without being limited to the electron beam pattern-drawing apparatus mentioned above. For example, the drawing method stated above may be applied on the structure wherein a drawing line on the other side of a base material is formed to be capable of drawing while a drawing line on one side of a base material is drafted.

Though an example to polarize and separate into three diffraction orders of 0-th order, −first order and +first order has been explained as “a hologram structure” in the invention, it is naturally possible to employ the structure to polarize and separate into optional diffraction orders (for example, 3 or more). In that case,

m=d(cos θi+cos θd)/α

is preferable when m represents a diffraction order, d represents a pitch of a grating in a plane, θi represents an angle formed between the advancing direction of an incident light and a normal line on a grating surface and θd represents an angle formed between the advancing direction of m-th order diffracted light and a normal line on a grating surface. Incidentally, “hologram structure” mentioned in the invention may include not only a function as the so-called hologram plate (polarizing and separating 0-th order, +first order and −first order) but also a function to conduct polarization and separation for the aforesaid optional diffraction order and a function to generate a spherical wave.

Further, the hologram structure may also be constituted by a combination of a binary pattern and a blaze (for example, the structure in which an inclined portion and a side wall portion/a concave bottom wall/an inclined portion and a side wall portion are repeated).

Further, various steps are included in the aforementioned embodiment, and various inventions can be extracted by an appropriate combination in a plurality of disclosed structural requirements. Namely, an example of a combination of the embodiments described above, or a combination of either one of the embodiments and either one of their variations is naturally included. In this case, with respect to action and effect which are self-evident from each structure disclosed in each embodiment and a variation even when they are not described in the present embodiment in particular, the action and effect can naturally be exhibited even in its example. Further, the structure wherein some structural requirements are eliminated from all of the structural requirements shown in the embodiment is also workable.

The description up to this point is one wherein an example of the embodiment of the invention is disclosed for easy understanding of the invention, and the aforesaid embodiment is one to exemplify, and it is not described to restrict, thereby, appropriate deformation and/or modification within a prescribed range is possible. Therefore, each factor disclosed in the embodiment is an objective that includes all design changes and equivalents belonging to the technical scope of the invention.

(Effect of the Invention)

As explained above, in the invention, it is possible to form an optical lens equipped with a hologram structure on a surface finally, by forming a hologram structure on a base material or on an optical element, synchronizing with drawing on a curved surface portion by drawing on a three-dimensional basis. Therefore, it may be possible to apply this to various equipment, in place of conventional hologram plate.

Owing to this, the element having the hologram structure can be manufactured successively on a mass production basis as a final molding made through injection molding, by fabricating a metal mold based on a base material. It is therefore possible to achieve sharp reduction of manufacturing cost and improvement of productivity, when labor and time in each process for forming hologram plates one by one in the past are taken into consideration.

Since it is possible to form an optical lens equipped with a wavelength plate function representing a double refraction phase structure on a surface finally, by forming a double refraction phase structure on a base material or on an optical element, it is possible to apply to various equipment, in place of a conventional wavelength plate.

Owing to this, the element having the wavelength plate function can be manufactured successively on a mass production basis as a final molding made through injection molding, by fabricating a metal mold based on a base material. It is therefore possible to achieve sharp reduction of manufacturing cost and improvement of productivity, when labor and time in each process for forming wavelength plates one by one in the past are taken into consideration.

Further, it is possible to achieve cost reduction in manufacturing, because a base material can be manufactured by injection molding employing a metal mold. When the base material is molded through injection molding, a hologram function and a function as a wavelength plate can be added simultaneously, and it is not necessary to add a process. Therefore, in comparison with an occasion for manufacturing hologram plates and wavelength plates one by one as in the past, it is possible to achieve sharp reduction of manufacturing cost and reduction of man-hours, which results in low cost of optical parts.

Incidentally, in addition to this, aberration correction under the condition of interchangeability between DVD and CD can be conducted properly by the base material on which a diffraction grating structure is formed on the surface on the other side.

In an optical pickup device, by using an optical element equipped with a hologram structure on its surface (molded integrally), it is possible to achieve sharp cost reduction by reducing the number of parts and by reducing the number of parts to be attached, without requiring an exclusive hologram plate which was used in the past.

In addition, a space occupied by members to be arranged is reduced because arrangement of hologram plates and wavelength plates turns out to be unnecessary, thereby, downsizing of an optical pickup device can be achieved, downsizing and integrating for an optical system of an optical pickup device are made to be easy, and a tracking mechanism can be simplified.

What is claimed is:

1. An optical element, comprising:
a first optical surface;
a second optical surface opposite to the first optical surface so that a light flux incident onto the first optical surface and is emitted from the second optical surface, wherein at least one of the first and second optical surfaces is a curved optical surface having a refracting power; and
a cyclic pattern structure having the characteristic of form birefringence and provided on the curved optical surface, wherein a distance of a pitch of a pattern in the cyclic pattern structure is smaller than the wavelength of the light flux.

2. The optical element of claim 1, wherein the second surface is the curved surface on which the cyclic pattern structure is provided in a form of a hologram structure to diffract the light flux into diffracted light rays having respective different diffraction orders.

3. The optical element of claim 1, wherein the hologram structure diffracts the light flux into at least 0-th order diffracted light rays, + first order diffracted light rays and − first order diffracted light rays.

4. The optical element of claim 3, wherein the hologram structure diffracts transverse electric wave of the light flux into + first order diffracted light rays and − first order diffracted light rays and transverse magnetic wave into 0-th order diffracted light rays.

5. The optical element of claim 2, wherein the hologram structure transmits a light flux incident onto the second optical surface so as to emit the light flux from the first optical surface.

6. The optical element of claim 2, wherein the hologram structure is a diffractive structure.

7. The optical element of claim 6, wherein the diffractive structure is a binary structure of convex and concave sections.

8. The optical element of claim 7, wherein a distance calculated by the sum of a width of a convex and a width of a concave is smaller than the wavelength of the light flux.

9. The optical element of claim 7, wherein the width of the concave section is smaller than that of the convex section.

10. The optical element of claim 6, wherein the diffractive structure is a structure of convex and concave sections, and in the convex, plural small-width convexes and plural small-width concaves are formed alternately.

11. The optical element of claim 10, wherein a distance calculated by the sum of a width of a convex and a width of a concave is smaller than the wavelength of the light flux.

12. The optical element of claim 1, wherein the first surface is the curved surface on which the cyclic pattern structure is provided in a form of a double refraction phase structure to provide a phase difference between two linearly polarized light rays which vibrate respectively in different directions perpendicular to each other on a plane intersecting a proceeding direction of the light flux.

13. The optical element of claim 12, wherein double refraction phase structure is a diffractive structure.

14. The optical element of claim 13, wherein the diffractive structure is a binary structure of convex and concave sections.

15. The optical element of claim 13, wherein the diffractive structure is a blaze structure of slope and side wall sections.

16. The optical element of claim 15, wherein each pitch of the cyclic pattern structure of the diffractive structure is formed by a slope portion and a side wall portion in such a way that a side wall portion is provided a boundary of each pitch and the slope portion is provided between two side walls.

17. The optical element of claim 15, wherein a distance calculated by the sum of a width of the slope portion and a width of the side wall portion is smaller than the wavelength of the light flux.

18. The optical element of claim 1, wherein the curved surface is provided so as to converge the light flux.

19. The optical element of claim 1, wherein the cyclic pattern structure is provided with an antireflection structure.

20. The optical element of claim 1, wherein the optical element is an objective lens.

21. The optical element of claim 1, wherein the optical element is a collimator lens.

22. The optical element of claim 1, wherein the optical element is made of a plastic material.

23. An optical pickup apparatus for conducting recording and/or reproducing information for an optical information recording medium, comprising:
a light source to emit a light flux;
an optical element to converge the light flux onto the optical information recording medium and to split the light flux reflected from the optical information recording medium into split light rays; and
a photo-detector to receive the split light rays and to detect a tracking error and a focusing error based the split light rays,
wherein the optical element including:
a first optical surface;
a second optical surface opposite to the first optical surface so that the light flux is incident onto the first optical surface and is emitted from the second optical surface, wherein at least one of the first and second optical surfaces is a curved optical surface having a refracting power; and
a cyclic pattern structure having the characteristic of form birefringence and provided on the curved optical surface, wherein a distance of a pitch of a pattern in the cyclic pattern structure is smaller than the wavelength of the light flux.

24. The optical pickup apparatus of claim 23, wherein the second surface is the curved surface on which the cyclic pattern structure is provided in a form of a hologram structure to diffract the light flux into diffracted light rays having respective different diffraction orders.

25. The optical pickup apparatus of claim 24, wherein the hologram structure diffracts the light flux into at least 0-th order diffracted light rays, + first order diffracted light rays and − first order diffracted light rays, and the photo-detector detects the tracking error and the focusing error based the +first order diffracted light rays and first − order diffracted light rays.

26. The optical pickup apparatus of claim 23, wherein the first surface is the curved surface on which the cyclic pattern structure is provided in a form of a double refraction phase structure to provide a phase difference between two linearly polarized light rays which vibrate in respective different directions perpendicular to each other on a plane intersecting a proceeding direction of the light flux.

27. The optical pickup apparatus of claim 23, wherein the optical element comprises a first optical element to make a light flux emitted from the light source into a parallel light flux and a second optical element to converge the parallel light flux onto the optical information recording medium, and wherein the first optical element has the curved surface on which the cyclic pattern structure is provided in a form of a hologram structure to diffract the light flux into diffracted light rays having respective different diffraction orders.

28. The optical pickup apparatus of claim 23, wherein the light source is a laser source to emit a laser beam.

29. The optical pickup apparatus of claim 23, wherein optical information recording medium is a magneto-optical recording medium.
